(19) United States
(12) Patent Application Publication
(10) Pub. No.: US 2024/0010028 A1
(43) Pub. Date: Jan. 11, 2024

(54) DEVICE FOR MOVING THROUGH A GRANULAR MEDIUM

(71) Applicant: CROVER LTD, Edinburgh Lothian (GB)

(72) Inventors: Lorenzo CONTI, Edinburgh Lothian (GB); Artem LUKIANOV, Edinburgh Lothian (GB)

(21) Appl. No.: 18/025,286

(22) PCT Filed: Sep. 9, 2021
(86) PCT No.: PCT/GB2021/052338

§ 371 Date: Mar. 8, 2023

(30) Foreign Application Priority Data
Sep. 11, 2020 (GB) 2014360.8

(51) Int. Cl. B60B 19/14

(52) U.S. Cl. CPC B60B 19/14; B60B 2900/721; B60Y 2400/301

(57) ABSTRACT

A device (1) for moving through a granular medium, the device comprising: a body (2); a rotatable part (4A, 4B) for rotational movement relative to the body about a rotational axis (6), wherein the rotatable part is externally-exposed and arranged to cause agitation of an adjacent portion of a granular medium in which the device is to be provided; a motor configured to cause the rotational movement of the rotatable part; and a protrusion (8) arranged to extend from the body and to limit rotational movement of the body about the rotational axis relative to the granular medium when the motor causes rotational movement of the rotatable part relative to the granular medium.

### FIELD OF THE INVENTION

The invention relates to a device for moving through a granular medium and methods of moving devices through granular media.

### BACKGROUND TO THE INVENTION

Few devices have been designed which are capable of movement through a granular medium such as grain or sand. Nevertheless, devices for movement through a granular medium could find many practical applications, for example in sensing or even mapping environmental conditions through a granular medium.

The few currently existing devices in this field typically achieve propulsion through granular media by way of translational displacement of grains on application of a normal force (for example, through the flapping of vanes) or by way of the lift force generated when an object is dragged horizontally through a granular medium. Such devices require the application of substantial forces in order to achieve propulsion, which leads to large stresses being exerted on the device bodies and effectively restricts operation to shallow or only semi-submerged states, since the forces required to translate grains typically increase with depth in granular media. These devices are generally inefficient and substantial translational motion of such devices is difficult to achieve as a result.

One example device is disclosed in WO 2019/086870A1 which discloses a method of propelling an object through a granular medium. The propulsion is achieved by rotation of one or more rotatable portions which act to agitate the granular medium sufficiently to cause local liquefaction (i.e., the formation of a liquid-like phase) of the granular medium.

It is in this context that the present disclosure has been devised.

### SUMMARY

According to an aspect of the present disclosure there is provided a device for moving through a granular medium. The device comprises: a body; and a rotatable part for rotational movement relative to the body about a rotational axis. The rotatable part is externally-exposed and arranged to cause agitation of an adjacent portion of a granular medium in which the device is to be provided. The device further comprises a motor configured to cause the rotational movement of the rotatable part. Rotational movement of the rotatable part relative to the granular medium causes movement of the device through the granular medium.

The device may comprise a protrusion arranged to extend from the body. The protrusion restricts (i.e., resists and/or limits, e.g., substantially prevents) rotational movement of the body about the rotational axis relative to the granular medium, for example when the motor causes rotational movement of the rotatable part relative to the granular medium. The protrusion may resist rotational movement of the device about the rotational axis when the motor causes rotational movement of the rotatable part relative to the granular medium.

Advantageously, the device can thus move in a direction having at least a component that is substantially transverse to the rotational axis more effectively than would be the case were the device not provided with the protrusion. It will be understood that the protrusion acts to effectively increase the resistance to rotational movement of the body relative to the granular medium by increasing the energy required to rotate the assembly of the protrusion and the body about the rotational axis in the granular medium. By reducing, restricting, or even completely eliminating the rotational movement of the body relative to the granular medium about the rotational axis, the rotational movement of the rotatable part relative to the granular medium about the rotational axis can be increased compared with devices not having a protrusion. In this way, it will be understood that more efficient and/or effective movement of the device through the granular medium can be achieved.

It will be understood that movement of the device through the granular medium refers to movement of the device in a direction having at least a component substantially transverse to the rotational axis.

In some examples, the movement of the device through the granular medium is achieved by causing agitation of the granular medium to a sufficient extent that local liquefaction of the granular medium is achieved in the adjacent portion of the granular medium. In other words, the granular medium can be considered to behave, at least partly, like a liquid in the adjacent portion, and can “flow” around the device.

Typically, the protrusion may extend sufficiently from the body of the device so as to be positioned away from the adjacent portion of the granular medium. In other words, the protrusion may extend into a region of the granular medium in which the extent of the local liquefaction of the granular medium is reduced, if not completely eliminated, in comparison with the adjacent portion of the granular medium.

The protrusion typically extends or projects in a direction having a component that is perpendicular to the (outer) surface of the body. The protrusion may extend or project in a direction having a component that is perpendicular to the outer surface of the rotatable part. The protrusion may extend or project in a direction having a component that is perpendicular to the surface of the device. For example, when the body is within the granular medium, the protrusion may extend into the granular medium. The protrusion thus provides an advantageous resistive force against rotation of the body relative to the granular medium, allowing the body to move more efficiently through the granular medium.

The protrusion may be integrally formed with the body. In other examples, the protrusion may be separately formed from the body and attached thereto during assembly of the device. In some examples, the protrusion may be attachable to and/or removable from the body. The device may comprise a plurality of protrusions. Accordingly, a protrusion (or protrusions) may be selected and/or configured, for example, in dependence on the specific granular medium in which the device is to be provided. This allows the device to be customised such that the device can move efficiently through different types of granular media, or in different environmental conditions.

The protrusion can sometimes be referred to as a tail or an anchor. In other words, the protrusion can be considered to be substantially any structural feature of the device to extend from the body into the granular medium and to resist rotational movement of the body about the rotational axis relative to the granular medium.

The protrusion may be tail-like. The protrusion may be limb-like. The protrusion may comprise a stud. The protrusion may comprise a ridge. The protrusion may comprise a bump. The protrusion may comprise a fin. Preferably, the protrusion is elongate. The term “elongate” in the context of the protrusion will be understood to mean that the protrusion has a length in a direction along the protrusion, away from the body, greater than an extent of the protrusion in any other orthogonal direction, such as a depth or a width. The protrusion may comprise a spine. It will be understood that the rotatable part is considered to be separate to the protrusion, and so the protrusion cannot be considered to be provided by the rotatable part.

In some examples, the device comprises a plurality, such as two, rotatable parts, each for rotational movement relative to the body about the same or separate rotational axes, and each arranged to cause agitation of one or more adjacent portions of the granular medium. In other words, in some examples, the device may comprise one or more rotatable parts. The one or more rotatable parts may be controlled together or independently.

The device is preferably configured such that, when the device is moving through the granular medium, the frictional forces that are generated between the granular medium and the protrusion are smaller than the frictional forces that are generated between the granular medium and the body. The device is preferably configured such that, when the device is moving through the granular medium, the frictional forces that are generated between the granular medium and the protrusion are smaller than the frictional forces that are generated between the granular medium and the or each rotatable part. In other words, the protrusion does not generate significant drag forces opposing movement of the device through the granular medium.

Preferably, the surface characteristics of the protrusion are such that the protrusion has a lower coefficient of friction than the coefficient of friction of the body. Thus, the protrusion does not generate significant drag forces opposing movement of the device through the granular medium. It will be understood that the term surface characteristics includes surface properties such as the microstructure or other properties of the surface which affect the friction between the protrusion and the surrounding granular medium during movement of the device through the granular medium.

A projected area of the protrusion in a plane transverse to a direction of movement of the device may be less than a projected area of the portion of the device not including the protrusion. Thus, the protrusion will typically not cause large levels of drag during movement of the device through the granular medium. The projected area of the protrusion may be less than 90 percent of the projected area of the portion of the device not including the protrusion. The projected area of the protrusion may be less than 50 percent of the projected area of the portion of the device not including the protrusion. The projected area of the protrusion may be less than 25 percent of the projected area of the portion of the device not including the protrusion. The projected area of the protrusion may be greater than 10 percent of the projected area of the portion of the device not including the protrusion.

The device may be moveable through the granular medium in a direction having at least a component that is perpendicular to the vertical (e.g. perpendicular to the direction of gravity). Thus, the device can be manoeuvred laterally within the granular medium. The device may be moveable through the granular medium in a direction having at least a component that is parallel to the vertical (e.g. parallel the direction of gravity, or optionally antiparallel to the direction of gravity). Thus, the device can be manoeuvred to be raised or lowered within the granular medium. Although the provision of a device having a protrusion provides the advantage of reducing the extent to which the device is able to rotate relative to the granular medium about the rotatable axis of the (e.g. one or more) rotatable part(s), the device may be configured to be rotatable relative to the granular medium about one or more other axes of rotation. The device may be configured to travel within the granular medium. For example, the device may be configured to travel to a predetermined location within the granular medium.

The device may be configured to travel to a randomly-selected location within the granular medium. The device may be configured to travel within the granular medium and to subsequently determine its location within the granular medium. The device may be configured to travel along a predetermined path within the granular medium. The device may be configured to travel along a randomly-generated path within the granular medium. The path may be a straight line. The path may comprise one or more path sections, having a plurality of different path directions.

The device may be moveable through the granular medium in a direction having at least a component that is perpendicular to the axis of rotation of the (e.g. one or more) rotatable part(s) and perpendicular to the vertical when the axis of rotation of the (e.g. one or more) rotatable part(s) is horizontal. The device may be moveable through the granular medium in a direction having at least a component that is inclined with respect to the axis of rotation of the (e.g. one or more) rotatable part(s) and perpendicular to the vertical when the axis of rotation of the (e.g. one or more) rotatable part(s) is horizontal. The device may be moveable through the granular medium in a direction having at least a component that is perpendicular to the axis of rotation of the (e.g. one or more) rotatable part(s) and perpendicular to the horizontal when the axis of rotation of the (e.g. one or more) rotatable part(s) is vertical. The device may be moveable through the granular medium in a direction having at least a component that is inclined with respect to the axis of rotation of the (e.g. one or more) rotatable part(s) and perpendicular to the horizontal when the axis of rotation of the (e.g. one or more) rotatable part(s) is vertical.

It may be that gradual rotational movement of the protrusion relative to the rotational axis can be achieved during movement of the device through the granular medium in the direction transverse to the rotational axis. Thus, the direction of the movement of the device can be changed within a plane defined transverse to the rotational axis.

The body may be moveable through the granular medium in a direction having at least a component that is perpendicular to the vertical (e.g. perpendicular to the direction of gravity). The body may be moveable through the granular medium in a direction having at least a component that is parallel to the vertical (e.g. parallel the direction of gravity, or optionally antiparallel to the direction of gravity). Although the provision of a device having a protrusion provides the advantage of limiting the extent to which the body rotates relative to the granular medium about the rotatable axis of the (e.g. one or more) rotatable part(s), the body may be rotatable relative to the granular medium about other axes of rotation. The body may be configured to travel within the granular medium. For example, the body may be configured to travel to a known location within the granular medium. The body may be configured to travel to a randomly-selected location within the granular medium. The body may be configured to travel to a predetermined location within the granular medium. The body may be configured to travel along a predetermined path within the granular medium. The body may be configured to travel along a randomly-generated path within the granular medium.

Where the device (e.g. the body of the device) comprises a plurality of rotatable parts, each rotatable part may be for rotational movement about a respective rotational axis. For example, the device (e.g. the body of the device) may comprise two rotatable parts, or may comprise three rotatable parts, or may comprise four rotatable parts. Where present, each rotatable part is externally-exposed and may be arranged to cause agitation of granular medium (for example, agitation of an adjacent portion of a granular medium in which the device is to be provided). Where a plurality of rotatable parts is provided, the device (e.g. the body of the device) may comprise a plurality of motors, each motor being operable to cause rotational movement of one of the plurality of rotatable parts independently of the or each other rotatable part. The or each rotatable part may be rotatably coupled to the body.

It may be that, when the device (e.g. the body of the device) is moving through the granular medium, the frictional forces that are generated between the granular medium and the protrusion are smaller than the total combined frictional forces that are generated both between the granular medium and the body and between the granular medium and the or each rotatable part. Thus, the addition of the protrusion does not significantly increase the drag of the device during movement of the device through the granular medium.

Rotation of the or each rotatable part may comprise at least one complete rotation (e.g. through 360°) of the said rotatable part, however this is not necessarily the case and rotation of the or each rotatable part may comprise one or more incomplete rotations (e.g. through less than 360°) of the said rotatable part. Rotation of the or each rotatable part may comprise more than one complete rotation (e.g. through more than 360°). Rotation of the or each rotatable part may comprise rotation at a constant angular velocity. Rotation of the or each rotatable part may comprise rotation at a variable or varying angular velocity. Where the device comprises a plurality of rotatable parts, it may be that the rotational velocity of each of the plurality of rotatable parts can be independently varied in one or both rotational directions.

It may be that the outer surface area of the protrusion is smaller than the outer surface area of the body. It may be that the outer surface area of the protrusion is smaller than the outer surface area of the (e.g. one or more) rotatable part(s) or the combined outer surface area of each rotatable part. It may be that the outer surface area of the protrusion is smaller than the combined outer surface area of the body and the or each rotatable part. Thus, typically the protrusion will have only a relatively small effect on the drag of the device during movement through the granular medium.

The outer surface area of the protrusion may contribute less than 15% to the total combined (e.g. summed) outer surface area of the body, the protrusion, and the (or each) rotatable part. Providing a protrusion that contributes less than 15% to the total combined (e.g. summed) outer surface area of the body, protrusion, and the (e.g. one or more) rotatable part(s) gives the advantage of a protrusion that provides a resistive force against rotation of the body about the rotational axis (thus allowing the body to travel efficiently through the granular medium) whilst limiting the contribution of the protrusion to the overall frictional forces on the device as it travels, thus resulting in a device which requires less energy in order for it to move through the granular medium than would otherwise be the case.

The outer surface area of the protrusion may contribute less than 10% to the total combined outer surface area of the body, the protrusion, and the (e.g. one or more) rotatable part(s). The outer surface area of the protrusion may contribute less than 5% to the total combined outer surface area of the body, the protrusion and the (e.g. one or more) rotatable part(s). For example, the outer surface area of the protrusion may be less than 15% of the total combined outer surface area of the body, the protrusion and the (e.g. one or more) rotatable part(s). The outer surface area of the protrusion may contribute at least 1% to the total combined outer surface area of the body, the protrusion and the (e.g. one or more) rotatable part(s). Thus, the protrusion can be sufficiently sized to provide resistance to rotation of the body about the rotational axis during movement of the (e.g. one or more) rotatable part(s) relative to the granular medium.

The protrusion may be elongate. As described hereinbefore, this will be understood to mean that the protrusion has a length which is greater than its depth or width. The protrusion may have a length which is at least 20% of the combined length of the protrusion and the body in a direction aligned with the direction of the length of the protrusion. Providing a protrusion with a length that is at least 20% of the combined length of the protrusion and the body has been found to be sufficient to help to resist the rotation of the body around the rotational axis. The protrusion may have a length which is at least 40% of the combined length of the protrusion and the body. The protrusion may have a length which is at least 50% of the combined length of the protrusion and the body. The protrusion is preferably of a length which is not more than 200% the length of the greatest dimension of the body. It will be understood that protrusions having too great a length may inhibit manoeuvrability of the device within the granular medium without a significant (or even any) increase in the effectiveness of the protrusion in resisting rotation of the body relative to the rotational axis.

A maximum extent of the (e.g. at least one of the one or more) rotatable part(s) in a direction transverse to the axis of rotation may be greater than 1 centimetre. The maximum extent of the (e.g. at least one of the one or more) rotatable part(s) in the direction transverse to the axis of rotation may be greater than 5 centimetres. The maximum extent of the (e.g. at least one of the one or more) rotatable part(s) in the direction transverse to the axis of rotation may be less than 5 metres. The maximum extent of the (e.g. at least one of the one or more) rotatable part(s) in the direction transverse to the axis of rotation may be less than 1 metre.

Preferably, the moment generated by the protrusion is substantially equivalent to the moment generated by the frictional forces between the (or each) rotatable part and the granular medium when the (or each) rotatable part is rotated. In other words, the protrusion is capable of generating a maximum reactive turning moment about the rotational axis greater than the maximum moment which can be generated about the rotational axis by the (e.g. or each) rotatable part due to friction between the (or each) rotatable part and the granular medium.

In some embodiments the device may comprise a tether. It will be understood that the tether may connect the body to a structure which is located external to the granular medium. This provides the advantage that the body may be easily retrieved by a user in the instance that a fault or an error occurs, for example an error which prevents the motion of the (e.g. one or more) rotatable parts. Furthermore, a tether allows electrical signals such as power, data and control signals to be communicated between the body of the device within the granular medium and the structure located external to the granular medium. Typically, a tether may be flexible. The tether may be sufficiently flexible so as not to interfere with manoeuvring of the device in the granular medium. Conversely, the protrusion may be substantially rigid. In some examples, the protrusion may be resiliently deformable.

In some embodiments, the protrusion may comprise a connector for connecting the protrusion to a tether. In this way, the tether may be connected to the body via the protrusion. A connector for connecting the protrusion to a tether provides a convenient way to securely connect the device to such a tether. Alternatively, although this is not preferred, the protrusion may be a tether. In some embodiments, the body may comprise a connector for connecting the body to a tether. The device may be separate from the tether.

In other examples, the device may be untethered.

The device may further comprise one or more agitating portions. The one or more agitating portions may be provided with the (e.g. one or more) rotatable part(s) to cause agitation of the adjacent portion of the granular medium. The one or more agitating portions may be provided as part of the (e.g. at least one of the one or more) rotatable part(s), or may be provided separate to the (e.g. at least one of the one or more) rotatable part(s). Typically, the one or more agitating portions are arranged to rotate with the (e.g. at least one of the one or more) rotatable part(s). The (e.g. at least one of the one or more) rotatable part may be an agitating portion.

It will be understood that an agitating portion is any part of the device having the properties as described herein and typically contributing to causation of movement of granular material when the (e.g. at least one of the one or more) rotatable part(s) is moved and when the device is submerged in the granular medium.

The one or more agitating portions may be a plurality of agitating portions. Each of the plurality of agitating portions may be separately mounted relative to the (e.g. one or more) rotatable part(s). The plurality of agitating portions may be distributed around an outer perimeter of the (e.g. one or more) rotatable part(s). The plurality of agitating portions may be distributed substantially throughout the outer perimeter of the (e.g. one or more) rotatable part(s). The outer perimeter may be a circumference of the (e.g. one or more) rotatable part(s) where the (e.g. one or more) rotatable part(s) has a circular cross-section.

At a first rotational position of the (e.g. one or more) rotatable part(s) relative to the body, the device may be configured such that a first portion of the (e.g. one or more) rotatable part(s) and the one or more agitating portions cause a first degree of agitation in a first region of the granular medium. At the first rotational position of the (e.g. one or more) rotatable part(s) relative to the body, the device may be configured such that a second portion of the (e.g. one or more) rotatable part(s) and the one or more agitating portions cause a second degree of agitation in a second region of the granular medium. At a second rotational position of the (e.g. one or more) rotatable part(s) relative to the body, the device may be configured such that the first portion of the (e.g. one or more) rotatable part(s) and the one or more agitating portions cause the second degree of agitation in the second region of the granular medium. Thus, the same portion of the (e.g. one or more) rotatable part(s) and the one or more agitating portions can cause different degrees of agitation in different rotational positions. Advantageously, this allows the device to use the different degrees of agitation in the different rotational positions to move the device through the granular medium. In other words, by providing the second degree of agitation in the second region of the granular medium in both the first rotational position and the second rotational position, the agitation in the second region of the granular medium may be maintained at the second degree to cause movement of the device.

This in itself is believed to be novel and so, in accordance with another aspect of the present disclosure, there is provided a device for moving through a granular medium. The device comprises: a body; a (e.g. one or more) rotatable part for rotational movement about a rotational axis, the (e.g. one or more) rotatable part being externally-exposed and arranged to cause agitation of an adjacent portion of a granular medium in which the device is to be provided; a motor configured to cause the rotational movement of the (e.g. one or more) rotatable part; and one or more agitating portions provided with the (e.g. one or more) rotatable part to cause the agitation of the adjacent portion of the granular medium. At a first rotational position of the (e.g. one or more) rotatable part relative to the body (i.e. the body of the device), the device is configured such that a first portion of the (e.g. one or more) rotatable part and the one or more agitating portions cause a first degree of agitation in a first region of the granular medium and a second portion of the (e.g. one or more) rotatable part and the one or more agitating portions cause a second degree of agitation in a second region of the granular medium. At a second rotational position of the (e.g. one or more) rotatable part relative to the body (i.e. the body of the device), the device is preferably such that the first portion of the (e.g. one or more) rotatable part and the one or more agitating portions cause the second degree of agitation in the second region of the granular medium.

Subsequently, at the first rotational position of the (e.g. one or more) rotatable part(s) relative to the body (i.e. the body of the device), the device may be configured such that the first portion of the (e.g. one or more) rotatable part(s) and the one or more agitating portions cause the second degree of agitation in the first region of the granular medium. Thus, the region in which the second degree of agitation is maintained can be changed away from the second region, such as to the first region. In this way, the device can be configured to move in a different direction.

The first degree of agitation is typically different to the second degree of agitation. The first rotational position is typically a different position to the second rotational position.

Advantageously, by providing a device configured such that different degrees of agitation of the granular medium can be caused by the same portions of the (e.g. one or more) rotatable part(s) (and the one or more agitating portions) at different rotational positions, movement of the device within the granular medium can be more easily controlled than would be the case if the device were not so configured. For example, this can allow the device to turn and/or to climb (e.g. move in a direction having at least an upwards component, against gravity) in the granular medium and/or to burrow in the granular medium (e.g. move in a direction having at least a downwards component, with gravity).

The one or more agitating portions may be moveable between a first position and a second position. The first position may be extended further than the second position. The first position may be extended further from an outer surface of the (e.g. at least one of the one or more) rotatable part(s) than the second position. The first position may be referred to as a maximally extended position. The second position may be referred to as a maximally retracted position. Advantageously, providing one or more agitating portions that are moveable between first and second positions allows a simple way for a range of degrees of agitation of the granular medium to be achieved when the (e.g. one or more) rotatable parts are moved. Thus, manoeuvrability of the device can be improved.

Typically, when the one or more agitating portions are in the first position (e.g., the maximally extended position) the one or more agitating portions cause a greater degree of agitation of the granular medium than when the one or more agitating portions are in the second position (e.g., the maximally retracted position). Typically, when the one or more agitating portions are in the second position (e.g., the maximally retracted position), the one or more agitating portions cause a lesser degree of agitation of the granular medium than when the one or more agitating portions are in the first position (e.g., the maximally extended position).

In some examples, the agitating portions may be configured to extend beyond an outer surface of the (e.g. at least one of the one or more) rotatable part(s).

In the maximally retracted position, the one or more agitating portions may not extend beyond the outer surface of the (e.g. at least one of the one or more) rotatable part(s). In the maximally retracted position, the one or more agitating portions may be substantially flush with the outer surface of the (e.g. at least one of the one or more) rotatable part(s). The one or more agitating portions may surround the (e.g. one or more) rotatable part(s). For example, the one or more agitating portions may surround the (e.g. at least one of the one or more) rotatable part(s) when (e.g. maximally or at least partially) extended. Preferably the agitating portions are moveable through a (e.g., continuous) range of (e.g., a plurality of) positions between the maximally extended position and the maximally retracted position.

Preferably, the one or more agitating portions are moveable relative to an outer surface of the (e.g. at least one of the one or more) rotatable part(s) in a direction having at least a component normal to the outer surface of the (e.g. at least one of the one or more) rotatable part(s). As such, this provides a device wherein the degree of agitation of the granular medium can be adjusted. Typically, moving the one or more agitating portions relative to the surface of the (e.g. at least one of the one or more) rotatable part(s) causes alteration of the degree of the agitation of the granular medium (i.e. when the or each rotatable part is caused to move relative to the granular medium).

For example, moving the one or more agitating portions relative to the surface of the (e.g. at least one of the one or more) rotatable part(s) may cause alteration of the degree of agitation of a portion of the granular medium adjacent to the agitating portion, or adjacent to the (e.g. at least one of the one or more) rotatable part(s), that is caused when the (externally-exposed) (e.g. one or more) rotatable part is caused to move relative to the granular medium.

Advantageously, by providing agitating portions that are movable between different positions (e.g. between a maximally extended position and a maximally retracted position) to cause different degrees of agitation of the granular medium (i.e. when the (e.g. one or more) rotatable parts are moved relative to the granular medium), a greater degree of control of the movement of the device through the granular medium is available than would be the case if the agitating portions were not so moveable. In particular, this provides the option for a user to select a degree of agitation of the granular medium according to how the user intends the device to move. For example, a user may select a position of the agitating portions which causes a greater degree of agitation of the granular medium (i.e. when the (e.g. one or more) rotatable parts are moved relative to the granular medium) when the device is at the surface of the granular medium, to thereby cause the device to burrow (i.e., to move from a surface position of the granular medium to a position submerged within the granular medium) into the granular medium. Alternatively, a user might for example select a position of the agitating portions which causes a lesser degree of agitation of the granular medium (i.e. when the (e.g. one or more) rotatable parts are moved relative to the granular medium) when the device is already submerged within the granular medium, in order to reduce the frictional resistance to movement of the device through the granular medium and thereby reduce the amount of energy needed to move the device at a given speed and/or in a given direction.

The device may be configured to determine an appropriate position for the agitating portions such that an appropriate degree of agitation of the granular medium is caused (i.e. when the (e.g. one or more) rotatable parts are moved relative to the granular medium). The device may be configured to achieve the determined position for the agitating portions based on the determination. For example, the device may be configured to adjust the position of the agitating portions in response to receiving a signal indicating that the device (or the body) is at the surface of the granular medium, or in response to a signal indicating that the device (or the body) is (at least partially) submerged within the granular medium. The device may be configured to adjust the position of the agitating portions in response to receiving a signal relating to a pressure, for example a pressure within the granular medium.

The device may further comprise a cam for engaging with the at least one of the one or more agitating portions during rotation of the (e.g. one or more) rotatable part(s) and the one or more agitating portions. The cam may be mounted rotatably independently of the (e.g. one or more) rotatable part(s). Typically, it will be understood that a cam defines a non-circular loop path for the at least one of the one or more agitating portions to follow during rotation of the (e.g. one or more) rotatable part(s). Thus, in the first rotational position, a first portion of the cam will cause the at least one agitating portion to extend from the first portion of the rotational part by a first amount, and at the second rotational position, a second portion of the cam, having a different spacing from a centre of the cam than the first portion of the cam, will cause the at least one agitating portion, rotated between the first rotational position and the second rotational position, to extend from the first portion of the rotational part by a second amount, different from the first amount.

The cam may be connected to the at least one of the one or more agitating portions.

The device may further comprise a cam motor. The cam motor may be operable to cause rotation of the cam (e.g. relative to the body and/or relative to the or each rotatable part and/or relative to the granular medium). Typically, without operation of the cam motor, the cam is configured to be rotationally fixed relative to the body. Where present, the cam and the cam motor are typically positioned beneath the outer surface of the (e.g. one or more) rotatable part(s). The cam may be connected to at least one of the one or more agitating portions. Accordingly, in some embodiments, movement of at least one of the one or more agitating portions between the first position and the second position is controllable via rotation of the cam (i.e. rotation of the cam causes movement of at least one of the one or more agitating portions between the first position and the second position). For example, rotation of the cam may cause movement of at least one of the one or more agitating portions. Rotation of the cam may cause extension and/or retraction of at least one of the one or more agitating portions. The provision of a cam connected to the agitating portions in this way allows a convenient way to adjust the degree of agitation caused by the one or more agitating portions when the (e.g. one or more) rotatable parts are moved.

Rotation of the cam to a first cam position may cause movement of a first region of the one or more agitating portions to the second position and movement of a second region of the one or more agitating portions to the first position. Rotation of the cam to a second cam position may cause movement of a third region of the one or more agitating portions to the second position and movement of a fourth region of the one or more agitating portions to the first position. Thus, movement of the cam can move at least one of the one or more agitating portions. The first region of the one or more agitating portions may be the same as the fourth region of the one or more agitating portions. The second region of the one or more agitating portions may be the same as the third region of the one or more agitating portions.

The device may define one or more (e.g., a plurality of) apertures through which the one or more agitating portions may be extended and/or retracted. The outer surface of the or each rotatable part may define one or more (e.g., a plurality of) apertures through which the one or more agitating portions may be extended and/or retracted. This allows the agitating portions to cause direct agitation of the granular medium when the (e.g. one or more) rotatable parts are moved. The one or more agitating portions may define the outer surface of the (e.g. the or each of the one or more) rotatable part(s).

It may be that at least one agitating portion is positioned substantially adjacent to at least one other agitating portion, for example, without a gap therebetween, when the agitating portions in the maximally retracted position. It may be that each agitating portion is positioned substantially adjacent to at least one other agitating portion, for example, without a gap therebetween, when the agitating portions are in the maximally retracted position. Where a gap is defined between agitating portions that gap may be smaller than the mean or median maximum extent (e.g. diameter) of the grains of the granular material in the granular medium. Where a gap is defined between agitating portion that gap may be smaller than the mean or median maximum extent (e.g. diameter) of dust particles in the granular medium. For example, a gap may define the distance between adjacent agitating portions, said distance being less than 10 centimetres, less than 5 centimetres, less than 1 centimetres, less than 0.5 centimetres, less than 1 millimetre, or less than 0.5 millimetres. A gap may define the distance between adjacent agitating portions, said distance being at least 0.1 micrometre, or at least 0.5 micrometres, or at least 1 micrometre. Adjacent agitating portions may be configured to be slidably moveable past each other.

The outer surface(s) of the or each rotatable part may be (e.g. substantially) smooth, e.g. except in the region(s) defining the apertures, where provided. The outer surface(s) of the or each rotatable part may be (e.g. substantially) continuous, e.g. except in the region(s) defining the apertures, where provided. The outer surface(s) of the or each rotatable part may comprise one or more recesses. The outer surface(s) of the or each rotatable part may comprise one or more grooves. The outer surface(s) of the or each rotatable part may comprise one or more dimples. The outer surface(s) of the or each rotatable part may comprise one or more bumps.

The one or more agitating portions may be greater than 1 millimetre in length. The one or more agitating portions may be greater than 5 millimetres in length. The one or more agitating portions may be less than 10 centimetres in length. The one or more agitating portions may be less than 3 centimetres in length.

The one or more agitating portions may be at least five agitating portions. The one or more agitating portions may be at least ten agitating portions. The one or more agitating portions may be at least fifteen agitating portions. The one or more agitating portions may be less than 10,000 agitating portions. The one or more agitating portions may be distributed substantially all the way around an outer circumference of the (e.g. at least one of the one or more) rotatable part(s).

The one or more agitating portions may be movable relative to an outer surface of the (e.g. at least one of the one or more) rotatable part(s) to alter a degree of agitation of the adjacent portion of the granular medium that is caused when the (e.g. at least one of the one or more) rotatable part(s) is caused to move relative to the granular medium. The one or more agitating portions may be movable in a direction having at least a component normal to the outer surface of the (e.g. at least one of the one or more) rotatable part(s).

This in itself is believed to be novel and so, in accordance with a still further aspect of the present disclosure, there is provided a device for moving through a granular medium. The device comprises: a body; a (e.g. one or more) rotatable part(s) for rotational movement about a rotational axis, the (e.g. one or more) rotatable part(s) being externally-exposed and arranged to cause agitation of an adjacent portion of a granular medium in which the device is to be provided; a motor configured to cause the rotational movement of the (e.g. one or more) rotatable part(s); and one or more agitating portions provided with the (e.g. one or more) rotatable part(s) to cause the agitation of the adjacent portion of the granular medium. The one or more agitating portions are movable relative to an outer surface of the (e.g. at least one of the one or more) rotatable part(s) in a direction having at least a component normal to the outer surface of the (e.g. at least one of the one or more) rotatable part(s) to alter a degree of agitation of the adjacent portion of the granular medium that is caused when the (e.g. at least one of the one or more) rotatable part(s) is caused to move relative to the granular medium.

A plurality of the one or more agitating portions may be movable together relative to the outer surface of the (e.g. at least one of the one or more) rotatable part(s). In other words, at least some of the one or more agitating portions which are movable may be extended together, or may be retracted together, to alter the degree of agitation caused by one or more agitating portions together when the (e.g. at least one of the one or more) rotatable part(s) is caused to move relative to the granular medium. Typically, when the at least some of the one or more agitating portions which are movable are extended, the degree of agitation caused when the (e.g. one or more) rotatable part(s) is caused to move is greater than when the at least some of the one or more agitating portions are retracted. Thus, the degree of agitation caused by the (e.g. one or more) rotatable part(s) can be increased or decreased as required depending on the desired operating conditions of the device. The present inventors have found particularly that increasing the degree of agitation by extending the one or more agitating portions can help the device to burrow from the surface of the granular medium into the granular medium. It may be that at least a quarter of the one or more agitating portions are movable together. It may be that at least half of the one or more agitating portions are movable together. It may be that more than half of the one or more agitating portions are movable together.

In some examples, the shape of the cam may be moveable between a first size in which the (e.g. one or more) rotatable part(s) and the one or more agitating portions are configured to cause a first degree of agitation and a second size in which the (e.g. one or more) rotatable part(s) and the one or more agitating portions are configured to cause a second degree of agitation, the second degree of agitation being greater than the first degree of agitation.

The device may comprise a sampling portion (e.g., a grain sampling portion). The sampling portion may be operable (e.g., controllable) to selectively capture a sample of the granular medium for removal from the granular medium. Thus, a sample of the granular medium can be taken, e.g., for analysis, from within the granular medium using a device for moving through the granular medium. Previously, sampling of granular media was not easily possible, and certainly not possible in a precise way, from locations throughout a granular medium. Current techniques involve use of hand-operated sampling tools only suitable for taking samples at or near a surface of a granular medium.

This in itself is believed to be novel and so, in accordance with a further aspect of the present disclosure, there is provided a device for sampling granular material from within a granular medium. The device comprises: a body; a (e.g. one or more) rotatable part for rotational movement about a rotational axis, the (e.g. one or more) rotatable part being externally-exposed and arranged to cause agitation of an adjacent portion of a granular medium in which the device is to be provided; a motor configured to cause the rotational movement of the (e.g. one or more) rotatable part to thereby move the device through the granular medium; and a sampling portion. The sampling portion is preferably operable to selectively capture a sample from the granular medium for removal from the granular medium.

It will be understood that the sample is a sample of granular material from the granular medium. It will further be understood that removal from the granular medium may be removal from the bulk region of the granular medium, e.g., into the device. In other examples, the removal may be from a container housing the granular medium, e.g., by removal of the device, or by removal from the granular medium via a conduit in fluid communication between an external storage container and the device.

The device may comprise one or more sensors. The one or more sensors may comprise at least one sensor for outputting a signal indicative of a position (e.g., a depth position) of the device within the granular medium. The at least one sensor may be a surface-position sensor. The or each surface-position sensor is preferably operable to record surface-position data, for example, including whether the body is at the surface of the granular medium and/or the distance between the body and the surface of the granular medium. In this way, it will be understood that the position signal can be referred to as surface-position data. Thus, a configuration of the device can be controlled in dependence on whether or not the device is at (or near) the surface of the granular medium.

The one or more sensors may be a plurality of sensors, of a plurality of different types.

The plurality of sensors may comprise one or more motion detectors. The one or more motion detectors may comprise one or more accelerometers. The one or more motion detectors may comprise one or more gyroscopes. The or each motion detector is preferably operable to record motion data, for example including the speed and/or direction of motion of the device, and/or the rate of acceleration of the device. Advantageously, providing one or more motion detectors aids with navigation of the device within the granular medium. In some embodiments, the one or more motion detectors may be configured to detect motion external to the device, in which case the one or more motion detectors may comprise one or more cameras.

The plurality of sensors may comprise one or more temperature sensors. The plurality of sensors may comprise one or more cameras. The plurality of sensors may comprise one or more pressure sensors. The advantage of providing a pressure sensor is that this allows a selection of a position of the agitating portions to be made in dependence on pressure data relating to (e.g. localised) pressure in the granular medium.

The device may comprise one or more moisture or humidity sensors. The device may comprise one or more (e.g. electronic) radiation sensors. The advantage of providing a device having one or more sensors comprising one or more temperature sensors, one or more cameras and/or one or more pressure sensors, is that the device can then provide information about the ambient conditions (e.g. the temperature, pressure, humidity etc.) within the granular medium.

The device may be provided with a controller. Typically, the controller is operable to control operation of the at least one motor of the device. The controller may be provided as part of the device. In other examples, the controller may be separate (e.g., external) to the device. The controller may be remote from the device. The controller may be operable to receive data and/or signals from one or more sensors. The controller may be operable to receive surface-position data from the surface-position sensor. The controller may be operable to receive a pressure signal from a pressure sensor. The controller may be operable to extend or retract the one or more agitating portions. For example, the controller may be operable to extend or retract the one or more agitating portions in response to surface-position data. The controller may be operable to extend or retract the one or more agitating portions in response to pressure data. The controller may comprise a processor, for example a microprocessor. Where present, the processor may be in electronic communication with a memory storing instructions configured to cause the device to operate as described herein. The instructions can be referred to as computer executable program code. It will be understood that in this way, the processor in combination with the memory storing the instructions can be considered to be the controller.

The controller may be configured to select (e.g., automatically select) an appropriate position for the one or more agitating portions such that an appropriate degree of agitation of the granular medium is caused (i.e. when the (e.g. one or more) rotatable parts are moved relative to the granular medium). For example, the controller may be configured to adjust the position of the one or more agitating portions in response to receiving a signal indicating that the device (or the body) is at the surface of the granular medium, or in response to a signal indicating that the device (or the body) is (at least partially) submerged within the granular medium. The controller may be configured to adjust the position of the agitating portions in response to receiving a signal relating to a pressure, for example a pressure within the granular medium.

The device may be controllable via the controller, for example by a user. The device may be controllable remotely. The device may be remote-controlled. The device may be at least partially-autonomous (e.g., autonomous).

The device may be a vehicle, for example a motorised vehicle. The vehicle may be remote-controlled. The vehicle may be autonomous. The vehicle may be an unmanned vehicle such as an unmanned underground vehicle (e.g. a drone).

The present disclosure extends to an assembly comprising the device and the controller in communication (e.g., wired communication or wireless communication) with the device.

The granular medium typically comprises a granular material. The granular medium typically comprises grains (e.g., particles). The granular material may comprise grains.

The grains typically have a mean (for example, volume-weighted mean or mass-weighted mean) or median (for example, volume-weighted median or mass-weighted median) maximum extent (e.g., diameter) of between 0.1 μm and 10 cm. For example, grains making up fine powders may have a mean (for example, volume-weighted mean or mass-weighted mean) or median (for example, volume-weighted median or mass-weighted median) maximum extent (e.g., diameter) of as low as 0.1 μm. In contrast, grains making up coarse powders may have a mean (for example, volume-weighted mean or mass-weighted mean) or median (for example, volume-weighted median or mass-weighted median) maximum extent (e.g., diameter) of around 0.05 mm, and, for example cereal grains may have a mean (for example, volume-weighted mean or mass-weighted mean) or median (for example, volume-weighted median or mass-weighted median) maximum extent (e.g., diameter) of up to around 5 mm, whereas pebbles may have a mean (for example, volume-weighted mean or mass-weighted mean) or median (for example, volume-weighted median or mass-weighted median) maximum extent (e.g., diameter) of the order of 1 cm to 10 cm.

The granular medium may comprise, for example, sand, soil, glass, ceramic, stone or rock (e.g. pebbles). The granular medium may comprise foodstuffs, for example beans (such as coffee beans, cocoa beans, haricot beans), cereal grain (such as maize or wheat) or powder (such as flour or cocoa powder). The grains may comprise, for example, sand, soil, glass, ceramic, stone or rock (e.g. pebbles). The grains may comprise foodstuffs, for example beans (such as coffee beans, cocoa beans, haricot beans), cereal grain (such as maize or wheat) or powder (such as flour or cocoa powder). The granular medium may comprise seeds.

The granular medium is preferably a dry granular medium, however in some embodiments the granular medium may be wet, or at least partially wet. The granular medium may, for example, comprise water or another liquid in the interstitial spaces between adjacent grains of the granular medium, although this is not preferred. A gaseous phase (e.g. air) is typically provided in the interstitial spaces between adjacent grains of the granular medium. A mixture of liquid and gas may be provided in the interstitial spaces between adjacent grains of the granular medium. The grains are typically (i.e. substantially) solid. The granular medium is typically a conglomeration of the said grains.

A maximum extent (e.g. a cross-section, such as a circular cross-section) of the (e.g. at least one of the one or more) rotatable part in a direction transverse to the rotational axis may be greater than a maximum extent (e.g., a mean maximum extent) of the grains forming the granular medium. This allows the device to move more easily within the granular medium than is the case where the (e.g. one or more) rotatable part has a size smaller than the grains forming the granular medium. The maximum extent (e.g. a cross-section, such as a circular cross-section) of the (e.g. at least one of the one or more) rotatable part in a direction transverse to the rotational axis may be greater than five times the maximum extent (e.g., a mean maximum extent) of the grains forming the granular medium, or preferably greater than ten times the maximum extent (e.g., a mean maximum extent) of the grains forming the granular medium, or more preferably greater than twenty times the maximum extent (e.g., a mean maximum extent) of the grains forming the granular medium. This provides the advantage of limiting the risk of grains getting stuck as the device moves through the granular medium, whilst also meaning that the device is large enough to be able to exert sufficient force on the granular material to cause the device to move through the granular medium. The maximum extent of the (e.g. at least one of the one or more) rotatable part may be less than 100 times the maximum extent (e.g., a mean maximum extent) of the grains forming the granular medium.

The or each of the one or more agitating portions can preferably be extended by a distance that is at least 25% of the (e.g. mean) diameter of the grains forming the granular medium, or preferably at least 40% of the (e.g. mean) diameter of the grains forming the granular medium, or preferably at least 60% of the (e.g. mean) diameter of the grains forming the granular medium. The or each of the one or more agitating portions can preferably be completely retracted (i.e. such that it does not protrude by any substantial distance beyond the outer surface of the (e.g. at least one of the one or more) rotatable part). The or each of the one or more agitating portions may be retracted beyond the outer surface of the or each rotatable part. For example, the or each of the one or more agitating portions may be retracted beyond the outer surface of the (e.g. at least one of the one or more) rotatable part such that a cavity (e.g., a depression) or a plurality of cavities in the (e.g. at least one of the one or more) rotatable part is defined by the or each of the one or more agitating portions and the outer surface of the (e.g. at least one of the one or more) rotatable part.

The or each rotatable part may be (e.g. substantially) circular in cross-section (e.g. when the agitating portions are in the retracted position). The or each rotatable part may have an external shape which is (e.g. substantially) convex (e.g. when the agitating portions are in the retracted position). The or each rotatable part may be elongate. The or each rotatable part may be (e.g. substantially) cylindrical. Preferably, the or each rotatable part is (e.g. substantially) hemispherical (e.g. when the agitating portions are in the retracted position), or oblate (e.g. substantially) hemispherical (e.g. when the agitating portions are in the retracted position). Preferably, the or each rotatable part is a wheel. Typically, the (e.g. one or more) rotatable part is not a helical or screw-shaped rotatable part. Typically, the or each (e.g. one or more) rotatable part is not a caterpillar track.

Although the device is a device for moving through a granular medium, the device is preferably also configured to be moveable on the surface of a granular medium. Accordingly, the device may further be a device for moving on the surface of a granular medium.

The axis of rotation of the or each rotatable part may be coincident with a longitudinal axis of the said rotatable part. The axis of rotation of the or each rotatable part may extend through the respective centre of mass of the said rotatable part. In some embodiments, the axis of rotation of the or each rotatable part may extend through the centre of mass of the body, however this is not required.

Viewed from another aspect, the present disclosure provides a method of causing movement of a device through a granular medium. The method comprises: introducing the device as described hereinbefore into the granular medium; receiving a control signal; and controlling the device to move through the granular medium in dependence on the control signal. Typically, the control signal is indicative of at least one of: a target position within the granular medium; a target direction; and/or a target speed for movement through the granular medium.

Controlling the device may comprise determining whether the device is at the surface of the granular medium in dependence on the signal indicative of the depth position of the device; moving the one or more agitating portions to a first agitating position to cause a first degree of agitation adjacent the (e.g. one or more) rotatable part, or a second agitating position to cause a second degree of agitation adjacent the (e.g. one or more) rotatable part in dependence on whether the device is determined to be at the surface of the granular medium; and causing the motor to rotate to thereby cause rotation of the (e.g. one or more) rotatable part and to thereby cause the first or second degree of agitation of the granular medium.

Thus, there is provided a particularly efficient method for moving the device through a granular medium, as well as for controlling the direction of the movement of the device through the granular medium.

Typically, the first degree of agitation is a degree of agitation which causes more agitation of the granular medium (i.e. when the (e.g. one or more) rotatable part is moved relative to the granular medium) than the second degree of agitation. The method may comprise moving the one or more agitating portions from a first agitating position, to a second agitating position and optionally to one or more further agitating position(s).

Typically, the first agitation position is one in which the plurality of agitating portions is maximally extended. The first agitation position may be the maximally extended position. Optionally, the second agitation position may be one in which the plurality of agitating portions is maximally retracted. The second agitation position may be the maximally retracted position, however this is not required and the second agitation position may be an intermediate position between the maximally extended position and the maximally retracted position.

The control signal may be indicative of a sampling location to which the device is to move. The method may further comprise, subsequent to the device being controlled to move through the granular medium to the sampling location in accordance with the control signal, capturing a sample of granular medium at the sampling location using the sampling portion. The method may further comprise removing the sample from the granular medium.

This in itself is believed to be novel and so, in accordance with an aspect of the present disclosure, there is provided a method of sampling a granular medium. The method comprises: introducing the device as described hereinbefore, and comprising the sampling portion, into a granular medium; controlling the device to move through the granular medium to the sampling location beneath the surface of the granular medium; and capturing a sample of the granular medium at the sampling location using the sampling portion. The method may further comprise removing the sample from the granular medium.

Thus, there is provided an efficient method of sampling the granular medium from a desired sampling location beneath the surface of the granular medium. In particular, such a sample can be captured more conveniently and more safely than would previously be the case. This is particularly advantageous because it does not require a person to manually collect a sample of the granular medium. By removing the sample of granular material from the granular medium, tests or analysis can be subsequently carried out on the said sample, externally to the granular medium, without a user needing to first manually retrieve the said sample.

The method may further comprise controlling the device to move to the surface of the granular medium (e.g. after a sample of granular medium has been captured). Advantageously, by moving the device to the surface of the granular medium after a sample of granular medium has been captured, a user may conveniently receive and remove the sample of granular medium from the granular material (for example, to thereafter carry out an analysis and/or one or more tests on the said sample) and optionally may also remove the device from the granular medium. The device may then either be returned to the same granular medium to capture a further sample, or may be introduced to a different granular medium (e.g., a different store of the same type of granular medium) to capture a sample from the different granular medium. Alternatively, the device may be removed from the granular medium and stored until it is next needed.

It may be that the method comprises analysing the sample of granular material. For example, the method may comprise receiving the sample of granular medium at the surface, and optionally carrying out one or more tests on the sample. Thus, analysis (and/or tests) may provide information about the sample which may in turn provide information about the granular medium as a whole.

In some embodiments the method my comprise carrying out one or more tests on the sample while the device is within (e.g. submerged within) the granular medium and optionally subsequently releasing the sample back to the granular medium, in which case the method may not comprise causing the device to move to the surface of the granular medium.

Typically, the granular medium is retained within a silo, for example a grain silo. However, the granular medium may be retained in any other container or may not be retained within a container. For example, the granular medium may comprise (e.g. be) a pile of granular material or a granular region of terrain.

Where the granular medium is retained within a silo or within another container, and where a tether is provided, the tether may connect the body to a structure which is located external to the silo or external to the container.

In some embodiments the method may comprise causing the grain sampling portion to capture (a) second and/or (a) subsequent sample(s) of granular material from the granular medium. Optionally, second and/or subsequent samples may be captured after a first sample has been released.

The device typically comprises a power source. For example, the device may comprise (and the power source may be) one or more batteries. The power source may be an external mains power source. The power source may be a generator. Where present, power may be supplied to the device via the tether. The tether may comprise a power cable. The tether may comprise a communications cable.

The protrusion may be detachable. The protrusion may comprise a detachable portion. In this way, the device can be provided with a changeable protrusion depending on the task or environment for which the device is to be used. At least one of any sensors may be provided in the detachable portion of the protrusion.

Features, integers, characteristics or groups described in conjunction with a particular aspect, embodiment or example of the disclosure are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any disclosed embodiments. The disclosure extends to any novel one, or any novel combination, of the features disclosed in this specification (including any accompanying claims, abstract and drawings), or to any novel one, or any novel combination, of the steps of any method or process so disclosed.

### DESCRIPTION OF THE DRAWINGS

Examples of relevance to the present disclosure will now be described with reference to the following Figures in which:

FIG. 1A is a perspective view diagram of an example of a device for moving through a granular medium;

FIG. 1B is a side elevation diagram of the device of FIG. 1A, FIG. 1C is a front elevation diagram of the device of FIG. 1A, and FIG. 1D is a plan view diagram of the device of FIG. 1A;

FIG. 2 is a contour plot showing an example of the effect of rotation of the rotatable parts (wheels) of the device 1 on the granular medium in which the device travels according to one of the ways in which the device could move;

FIG. 3A is a perspective view diagram of a further example of a device for moving though a granular medium;

FIG. 3B is a side elevation diagram of the device of FIG. 3A, FIG. 3C is a front elevation diagram of the device of FIG. 3A, and FIG. 3D is a plan view diagram of the device of FIG. 3A;

FIGS. 4A to 4F are a series of cut-away perspective view diagrams of the rotatable part (wheel) of the device of FIGS. 3A to 3D;

FIG. 5 is a flow chart of example steps in a method of moving a device for moving through a granular medium;

FIG. 6A is a perspective view diagram of another device for moving through a granular medium and capturing a sample of granular material;

FIG. 6B is a side elevation diagram of the device of FIG. 6A, FIG. 6C is a front elevation diagram of the device of FIG. 6A, and FIG. 6D is a plan view diagram of the device of FIG. 6A;

FIG. 6E is a cut-away perspective view diagram of the device of FIG. 6A;

FIG. 7 is a flow chart of example steps in a method of capturing a sample of granular material according to an aspect of the disclosure;

FIG. 8 is a cut-away front elevation diagram of equipment for removing a captured sample according to an example of the disclosure; and

FIG. 9 is a diagram showing a further example of a device as disclosed herein.

### DETAILED DESCRIPTION OF AN EXAMPLE EMBODIMENT

It will be understood by those skilled in the art that any dimensions and relative orientations such as lower and higher, above and below, and any directions, such as vertical, horizontal, upper, lower, axial, radial, longitudinal, tangential, etc., referred to in this application are within expected structural tolerances and limits for the technical field (here including devices for moving through granular media) and the apparatus and methods described, and these should be interpreted with this in mind.

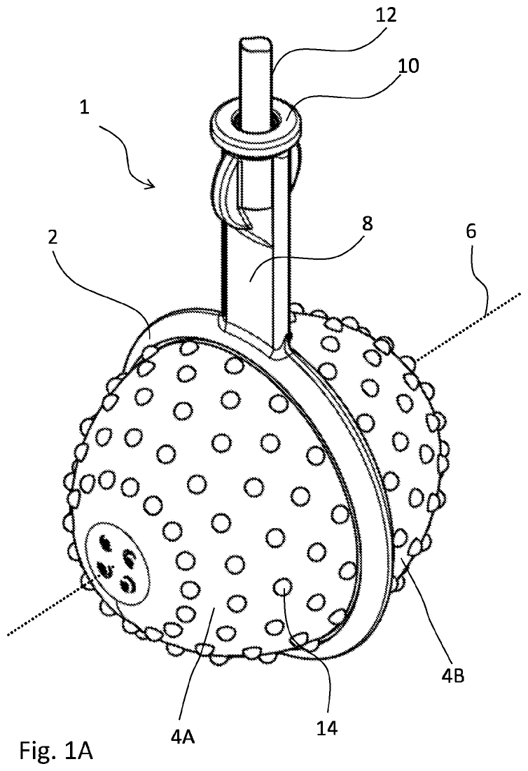

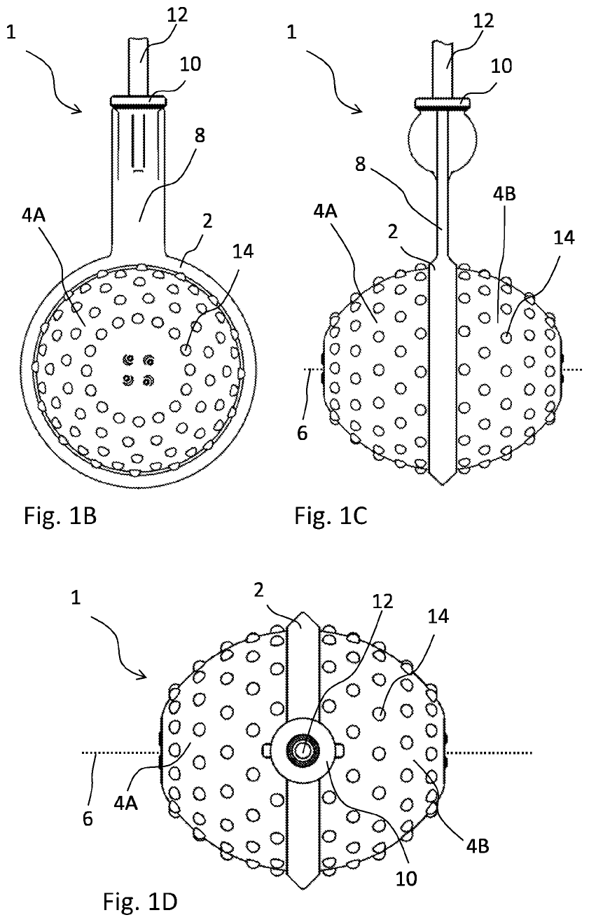

FIG. 1A is a diagram showing an example of a device 1 for moving through a granular medium made up of granular material. The device 1 has a generally spherical shape, and comprises a body 2 and first and second rotatable parts in the form of two generally hemispherical wheels 4A, 4B located at either side of the body 2 and for rotation relative thereto. The device 1 comprises two motors (not shown in FIG. 1A) and a dedicated power source (not shown) each mounted relative to the body 2 and together for driving rotation of the wheels 4A, 4B relative to the body 2, about a rotation axis 6. A protrusion 8 in the form of a narrow, elongate protrusion 8 extends from the body 2. The protrusion 8 extends in a direction transverse to the axis of rotation 6. The protrusion 8 comprises an end portion 10 from which extends a tether 12 in the form of a tether cable 12 for communication of control signals and sensor data between the device 1 and a further component (not shown). The outer surface of each wheel 4A, 4B is provided with a plurality of agitating portions 14 in the form of a plurality of raised bumps 14. FIGS. 1B, 1C, and 1D are side and front elevation diagrams and a plan diagram of the device 1 of FIG. 1A.

The device 1 is typically provided with a controller (not shown) for controlling operation of the motors and/or of the wheels 4A, 4B. The device 1 may be provided with a processor (in electronic communication with a memory storing computer executable program code) programmed to control the movement of the device 1 through a granular medium, for example by directing the device 1 along a pre-programmed path.

The device 1 is further provided with one or more sensors (not shown) for sensing one or more characteristics of an external environment of the device 1. For example, in an example embodiment, the device has one or more temperature sensors operable to measure temperature and to transmit a temperature signal (for example, to the controller or to a user or to an external device). The device 1 is provided with one or more surface position sensors operable to detect whether the device 1 is at the surface of the granular medium and to transmit a signal indicative of whether the device 1 is at the surface of the granular medium (for example, to the controller or to a user or to an external device).

In some alternative examples, the device 1 is also provided with one or more humidity sensors operable to measure humidity and to transmit a humidity signal (for example, to the controller or to a user or to an external device) and/or one or more moisture sensors operable to measure moisture and transmit a moisture signal (for example, to the controller or to a user or to an external device) and/or one or more motion sensors (e.g. one or more accelerometers and/or one or more gyroscopes) etc operable to detect motion and transmit a motion signal (for example, to the controller or to a user or to an external device).

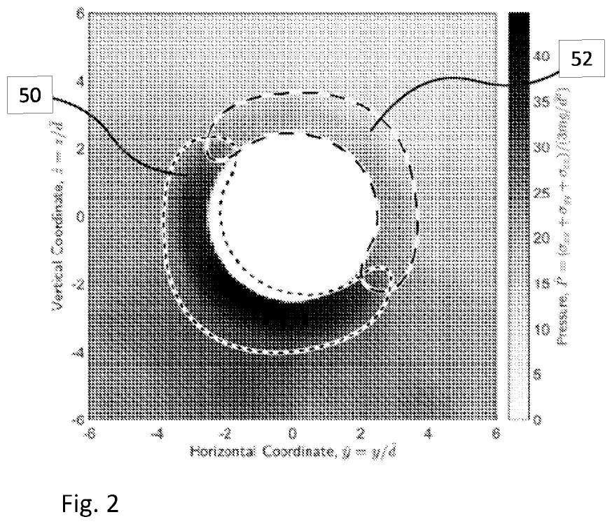

The inventor has found that, when the device 1 is submerged in a granular medium, rotation of the wheels 4A, 4B about the rotation axis 6 causes the device 1 to travel through the granular medium. Specifically, the two motors generate a torque on the wheels 4A, 4B which in turn generates a rotation torque of the body in the opposite rotational direction. Rotation of wheel 4A can be driven independently of rotation of wheel 4B, and vice versa. When the wheels 4A, 4B are rotated relative to the body 2 with the device 1 submerged within a granular medium, the protrusion 8 resists the rotational movement of the body 2 relative to the granular medium about the rotation axis 6 thus allowing the wheels 4A, 4B to rotate relative to the granular medium about the rotation axis and causing the device 1 to move efficiently through the granular medium, as will be described further with reference to FIG. 2 hereinafter.

The device 1 can travel vertically and horizontally and transversely through the granular medium and can turn, with the direction of motion being adjustable by adjusting the speed and direction of rotation of the motors (and thus the wheels 4A, 4B). The device 1 can also travel on the surface of the granular medium. The agitating portions 14 cause agitation of the granular material, when the wheels 4A, 4B are rotated. The agitating portions 14 can also provide at least some friction (i.e., grip) between the wheels 4A, 4B and the granular medium during rotation of the wheels 4A, 4B. It will be understood that the speed of rotation of the wheels 4A, 4B can be varied to vary the degree of agitation of the granular medium and/or the degree of grip between the wheels 4A, 4B and the granular medium.

In practice, movement of the device through the granular medium can be achieved with rotation of the rotatable portions through a wide range of angular velocities, for example between 0.1 Hz (i.e. 0.1 complete revolutions per second) and 10 Hz (i.e. 10 complete revolutions per second), in some cases even up to 100 Hz, with the particular angular velocity selected based on device parameters such as device shape, size and weight as well as the nature of the granular material.

The tether 12 can be used to retrieve the device 1, for example if the device 1 develops a fault or stops moving.

FIG. 2 is a contour plot showing an example of the effect of rotation of the wheels 4A, 4B of the device 1 on the granular medium in which the device 1 travels, according to one way in which the device 1 could move. In particular, movement of the rotatable parts 4A, 4B relative to the granular medium with sufficient angular velocity causes the agitating portions 14 to agitate the grains of the granular medium. With sufficient agitation, the grains of the granular medium can be considered to exhibit some liquid-like properties. In this way, the effect can be referred to as liquefaction. Furthermore, the rotation causes the formation of a relatively higher-pressure region 50 within the granular medium on one side of the wheels 4A, 4B of the device 1, generally on a lower-left side of the device 1, and a correspondingly relatively lower-pressure region 52 forming within the granular medium on the opposite side of the device 1. Generally on an upper-right side of the device 1. Accordingly, it will be understood that the device 1 will move in accordance with the pressure gradient defined between the higher-pressure region 50 and the lower-pressure region 52, in particular in the direction of the lower-pressure region 52. FIG. 2 shows the situation with clockwise rotation of the wheels 4A, 4B in the centre of the figure. It will be understood that with anti-clockwise rotation of the wheels 4A, 4B, the higher-pressure region 50 would be located generally on a lower-right side of the device 1, and the lower-pressure region 52 would be located generally on an upper-left side of the device 1. In the example shown in FIG. 2, the density of the device is greater than the density of the granular medium. Accordingly, if the density of the granular medium is instead greater than the density of the device, the mechanism will change, such that the higher-pressure region 50 would be located at least partially above the device and the lower-pressure region 52 would be located at least partially below the device.

Because the device 1 is provided with a protrusion 8, the protrusion 8 provides resistance against rotation of the device 1 around the rotation axis 6, thus allowing the device 1 to move through the granular medium more efficiently, with less energy lost to unwanted rotational movement of the body 2 relative to the granular medium. Because the protrusion 8 is elongate and narrow, the frictional forces between the protrusion 8 and the granular material when the device 1 moves through the granular medium are relatively small, allowing the device 1 to move through the granular medium with relative ease. Specifically, the frictional forces between the protrusion 8 and the granular medium are small in comparison to the frictional forces between the wheels 4A, 4B and the body 2 when the device moves through the granular medium. As such, the protrusion 8 provides the advantage of limiting rotational movement whilst not contributing significantly to drag on the device 1 as the device moves. This makes the movement of the device more efficient than would otherwise be the case.

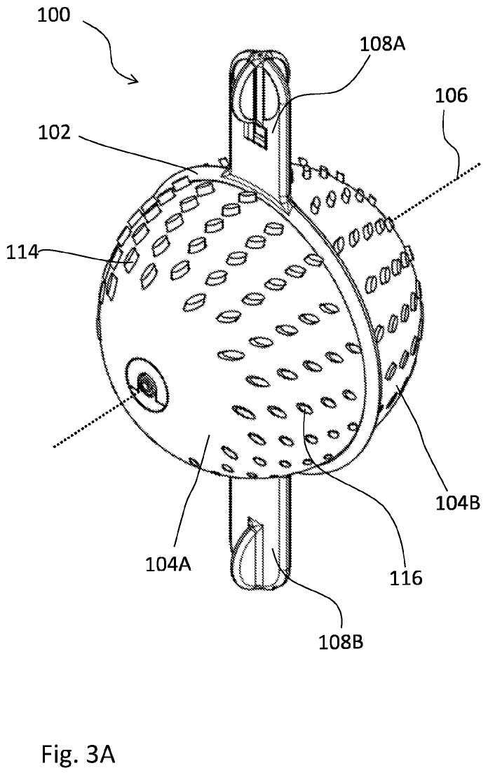

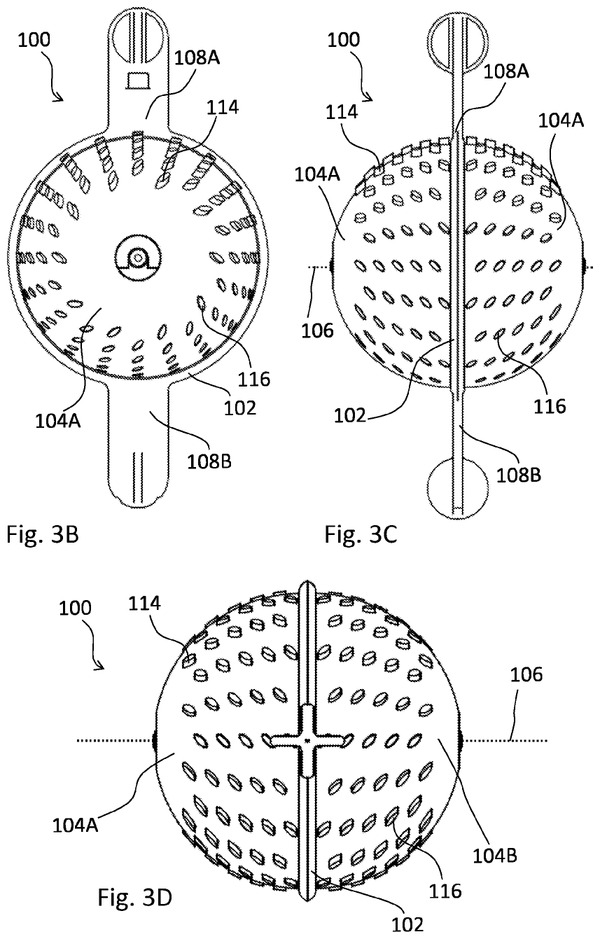

FIG. 3A is a diagram of a further example of a device 100 for moving through a granular medium made up of granular material. The device 100 is generally spherical and includes a body 102 and first and second generally hemispherical rotatable parts in the form of two wheels 104A, 104B mounted at either side of the body 102 for rotation relative to the body 102. The outer surface of each wheel 104A, 104B defines a plurality of apertures 116 through which a plurality of moveable agitating portions 114 may be extended and/or retracted. Here the plurality of agitating portions 114 are provided in the form of generally cylindrical prisms. The body 102 contains two wheel motors (not shown in FIG. 3A), two cams (not shown in FIG. 3A), two cam motors (not shown in FIG. 3A) and a dedicated power source (not shown). Each cam is connected to the plurality of moveable agitating portions 114 of one of the wheels 104A, 104B. The two wheel motors are for driving rotation of the wheels 104A, 104B, about a rotation axis 106. The cam two motors are for driving rotation of the two cams. Two protrusions 108A, 108B, in the form of two narrow, elongate protrusions 108A, 108B extend from the body 102 one each in opposite directions transverse to the rotational axis 106. FIGS. 3B, 3C, and 3D are side and front elevation diagrams, and a plan diagram of the device 1 of FIG. 3A, respectively.

Rotation of wheel 104A can be driven independently of rotation of wheel 104B, and vice versa. Rotation of the wheels 104A, 104B can be driven independently of rotation of the cams.

As in the example embodiment shown in FIGS. 1A to 1D and described above, when the device 100 is submerged in a granular medium, rotation of the wheels 104A, 104B about the rotation axis 106 causes the device 100 to travel through the granular medium. Specifically, the two wheel motors generate a torque on the wheels 104A, 104B which in turn generates a rotation torque of the body in the opposite rotational direction. The protrusions 108A, 108B then act to resist the rotational movement of the body 102 about the rotation axis 106 thus allowing the device 100 to travel within the granular medium more effectively.

As described hereinbefore with reference to FIGS. 3A to 3D, the agitating portions 114 both provide grip and cause agitation of the granular material, when the wheels 104A, 104B are rotated. Rotation of the cam motors drives rotation of the cams, which in turn drives movement of the agitating portions 114 such that the agitating portions 114 are extended and/or retracted through the apertures 116 in the outer surfaces of the wheels 104A, 104B. In this way, both the degree of grip and the degree of agitation of the granular material can be adjusted.

As a result of the cams provided to engage with the agitating portions 114 of each of the wheels 104A, 104B, it can be seen that the agitating portions 114 on a first side of the wheels 104A, 104B, substantially adjacent the first protrusion 108A, extend further from an outer surface of the wheels 104A, 104B than the agitating portions 114 on a second side of the wheels 104A, 104B, substantially adjacent the second protrusion 108B. Thus, the agitation and/or grip provided by the agitating portions 114 is different at the first side and the second side of the wheels 104A, 104B. The cams are configured to be mounted rotationally independently of the wheels 104A, 104B. In this way, when the wheels 104A, 104B rotate, without rotation of the cams, the agitating portions 114 remain more extended from the outer surface of the wheels in the region adjacent the first protrusion 108A than in the region adjacent the second protrusion 108B. Therefore, a degree of agitation of the granular medium is greater in a region of the granular medium adjacent the first protrusion 108A than in the region of the granular medium adjacent the second protrusion 108B, regardless of the rotational position of the wheels 104A, 104B.

Put another way, as a wheel 104A, 104B is rotated, the wheel moves from a first rotational position relative to the body 102 to a second rotational position relative to the body 102 (and indeed would typically continue to move to further rotational positions). At a first rotational position of the wheel 104A, 104B relative to the body 102, the agitating portions 114 are positioned (e.g. extended or retracted) such that the agitating portions 114 at a first portion of the wheel 104A, 104B cause a first degree of agitation in a first region of the granular medium and the agitating portions 114 at a second portion of the wheel 104A, 104B cause a second degree of agitation in a second region of the granular medium. Then, when the wheel 104A, 104B is rotated to a second rotational position relative to the body 102, the agitating portions 114 at the first portion of the wheel 104A, 104B cause the second degree of agitation in the second region of the granular medium.

The advantage of extendible and retractable agitation portions 114 and thus of adjustable grip and an adjustable degree of agitation of granular material (i.e., as the wheels 104A, 104B are rotated) is that this provides improved manoeuvrability of the device 100 as it travels through the granular medium.

By rotating the cams, the region of the granular medium to be agitated can be changed. It will be understood that the cams can be rotated independently for each of the wheels 104A, 104B.

Furthermore, the plurality of agitation portions 114 may be moveable together (e.g. extendible and/or retractable). For example, in one example embodiment, all agitating portions 114 may be extended (or retracted) though their respective apertures 116 together, such as by the same amount, and/or by the same proportional amount. In this way, the device 100 can be configured differently depending on the precise environmental conditions, such as the type of granular medium, or the position of the device within the granular medium (such as whether the device is at the surface or instead submerged within the granular medium).

In other words, all of the agitating portions 114 can be extended (e.g. fully) when the device 100 is at the surface of the granular medium. Because the agitating portions cause a greater degree of agitation when fully extended, this has the effect of encouraging the device 100 to bury itself in the granular medium when the wheels 104A, 104B are rotated. Conversely, when the device 100 is submerged within the granular medium, the agitating portions 114 can each be (e.g. fully) retracted to limit the frictional forces on the wheels 104A, 104B when the wheels 104A, 104B are rotated, thereby improving the efficiency of the travel of the device 100 within the granular medium.

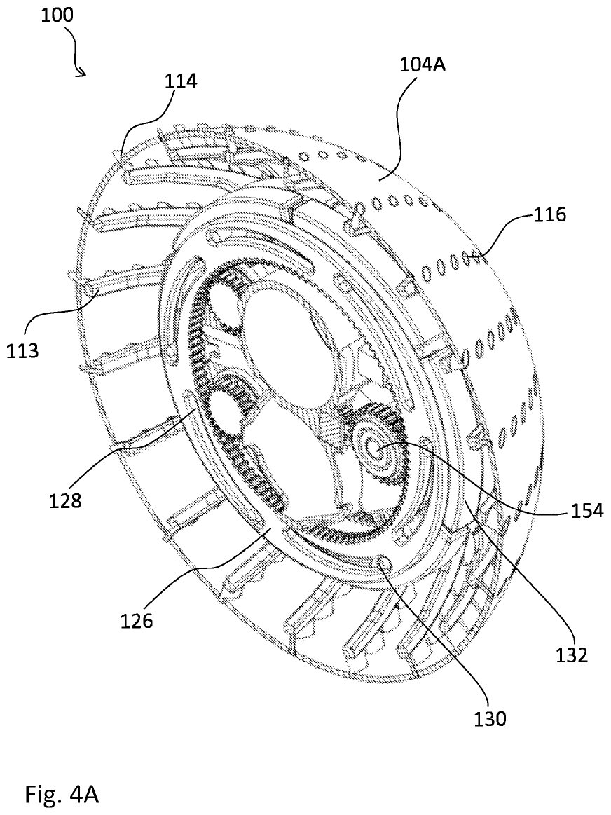

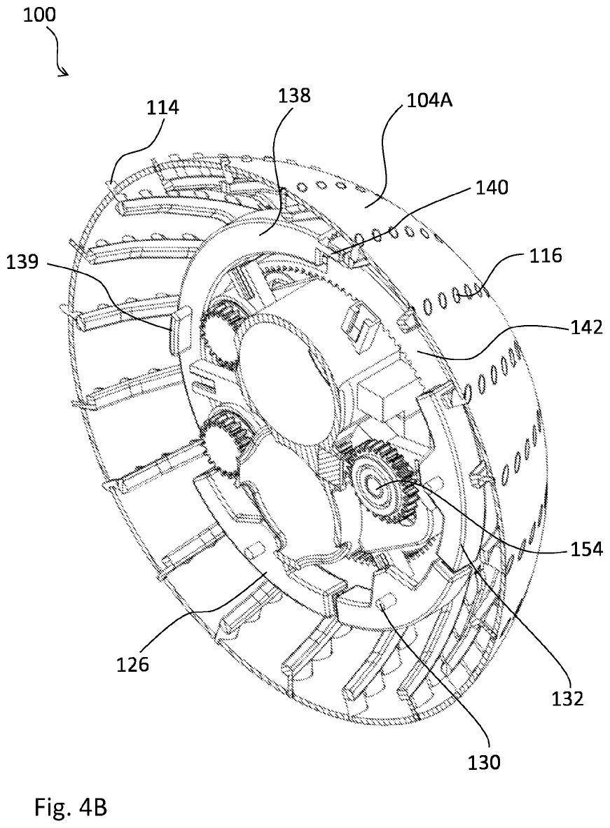

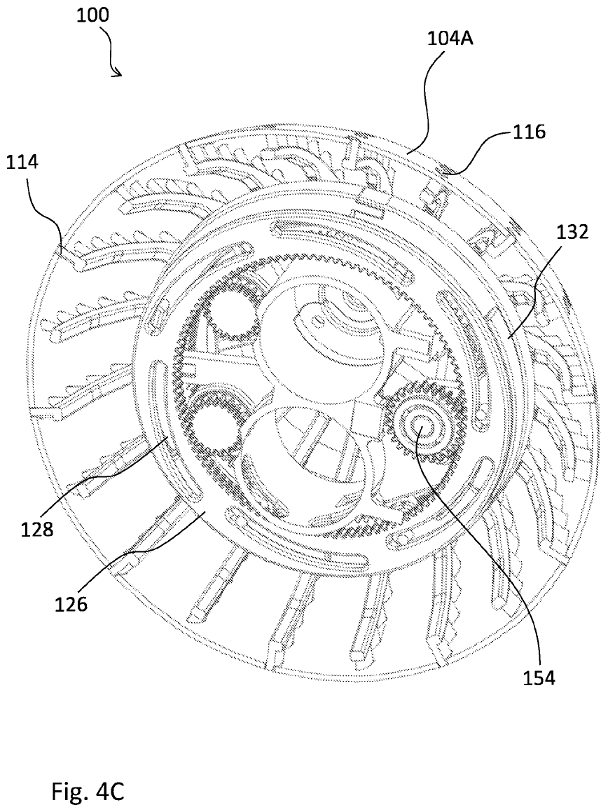

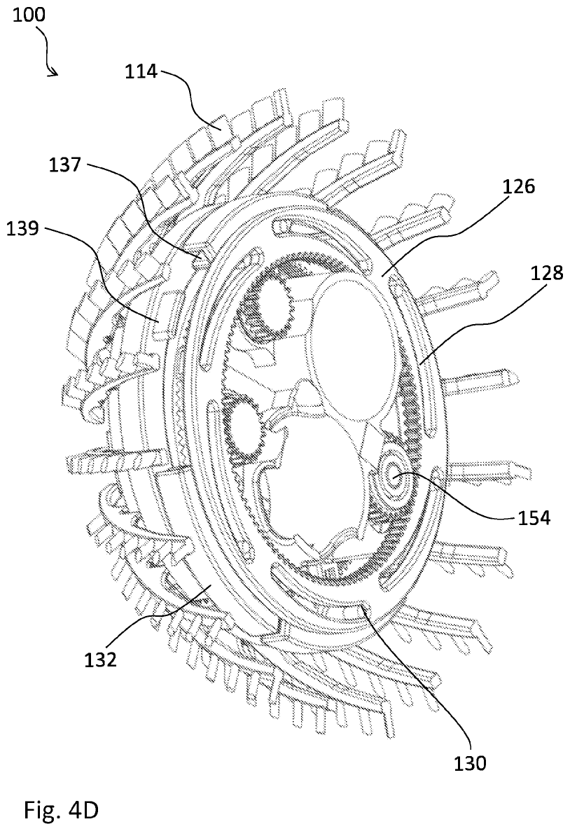

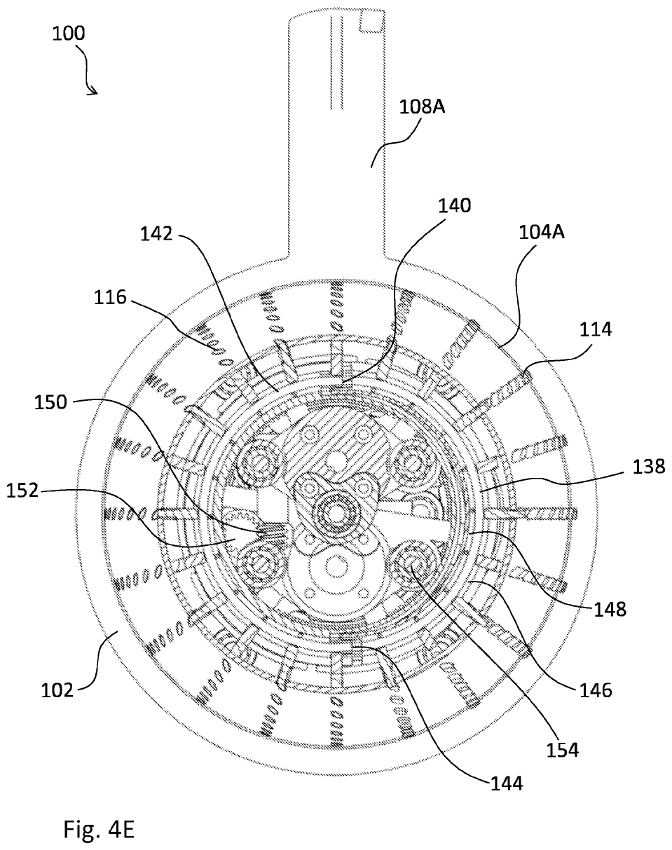

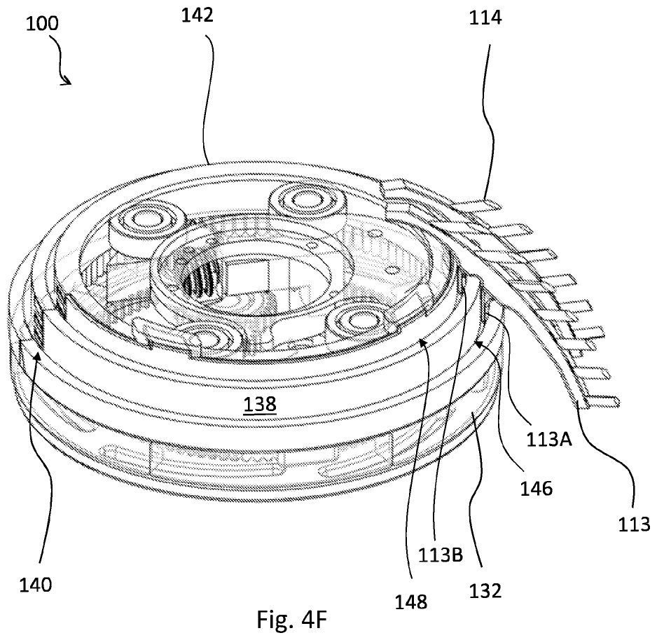

FIGS. 4A to 4D are a series of cut-away perspective view diagrams of the rotatable part (wheel) of the device 100 as shown in FIGS. 3A to 3D (protrusion not shown) and discussed above and FIG. 4E is a cut-away front elevation diagram of the rotatable part (wheel) of an example embodiment equivalent to the device 100 as shown in FIGS. 3A to 3D (but having only one protrusion). FIG. 4F is a diagram of internal components of the device shown in FIGS. 3A to 3D, showing aspects of the inner workings of the rotatable part shown in FIGS. 4A to 4E. It will be understood that some components of the device 100 are hidden in some of the figures to better illustrate other components of the device 100.

Referring to FIGS. 4A to 4F, one example way in which the agitating portions 114 can be controlled to extend through the apertures 116 can be seen. A plurality of agitating portions 114 are provided on an agitating portion undercarriage 113, aligned with a plurality of apertures 116 defined in the wheel 104A. As can be seen in FIG. 4A, the wheel 104A is provided with a plurality of the agitating portion undercarriages 113. Each agitating portion undercarriage 113 is engaged with a track 146, 148, in this example a plurality of tracks 146, 148 (best seen in FIG. 4F), defined within an internal structure within the wheel 104A, in the form of each of two semi-circular portions 138, 142. The agitating portion undercarriage 113 comprises a plurality of track engagement protrusions 113A, 113B, one each for engaging within each of the tracks 146, 148. In this way, the tracks 146, 148 define an extent to which the agitating portions 114 of the agitating portion undercarriage 113 extend through the apertures 116 from the outer surface of the wheel 104A. As the wheel rotates about the rotational axis, the agitating portion undercarriage 113 rotates therewith relative to the tracks 146, 148 which are rotationally independent of the wheels 104A. In this way it will be understood that any lateral movement of the tracks 146, 148 in the internal structure within the wheel, in a direction towards or away from the surface of the wheel 104A, will change the extent to which the agitating portions 114 of the agitating portion undercarriages 113 extend through the apertures 116 at the region of the wheel adjacent the particular portion of the track.

The tracks 146, 148 of FIGS. 4A to 4F can be moved by two interdependent mechanisms, each of which will now be described.

Firstly, as shown in FIG. 4A, there is provided a ring piece 126, having defined therein a plurality of arcuate slots 128, in this example six arcuate slots 128. Each of the plurality of arcuate slots 128 extends from a first position to a second position. The second position is radially outward and circumferentially spaced from the first position. A corresponding plurality of expanding arcs 132 are moveably mounted relative to each of the arcuate slots 128 via locating pegs 130 engaged within the arcuate slots 128. In the example shown in FIG. 4A, the locating legs are provided adjacent the second position of the arcuate slots 128, forcing the expanding arcs 132 to a radially outermost position. As shown in FIG. 4D, an opposite side of the expanding arcs 132 defines an expanding arc track 137 for engagement by locator portions 139 of the two semi-circular portions 138, 142. The agitating portion undercarriages 113 engage with the tracks 146, 148 (shown best in FIGS. 4E and 4F) defined in an opposite side of the semi-circular portions 138, 142 to the locator portion 139.

The ring piece 126 is internally toothed and engaged by a driven gear 154 to cause rotational movement of the ring piece 126 relative to the expanding arcs 132 and thereby cause radial movement inwardly or outwardly of the expanding arcs 132 in a direction transverse to the rotational axis. The retracted position of this mechanism is shown in FIG. 4C.

The two semi-circular portions 138, 142 each define semi-circular portions of a circle (i.e., having a substantially constant radius of curvature). As best seen in FIG. 4F, the two semi-circular portions 138, 142 are connected via first and second expandable connections 140, 144 allowing slight lateral movement between the semi-circular portions 138, 142, such that the two semi-circular portions 138, 142 define a circular portion of the tracks 146, 148 for each of the semi-circular portions 138, 142 and a short, approximately straight portion of the tracks 146, 148 in a transition region between the semi-circular portions 138, 142. In this way, it can be seen that in an expanded configuration, the tracks 146, 148 will define a non-circular path. As a result, the agitating portions 114 will be caused to extend further from the wheel 104A when passing through a midway portion of the tracks 146, 148 defined by a central region of each of the semi-circular portions 138, 142. The greater the expansion between the two semi-circular portions 138, 142 at the expandable connections 140, 144, the greater the degree of extension of the agitating portions 114 from the wheel 104A at the central region of the semi-circular portions 138, 142. Similarly, the agitating portions 114 will extend less far from the wheel 104A (or even not at all) in the region of the expandable connections 140, 144. As will be understood, the degree of expansion for the two semi-circular portions 138, 142 is controlled by movement of the expanding arcs 132 as described hereinbefore. In this way, the degree of agitation caused by the agitating portions 114 can be altered. In this way, the tracks 146, 148 defined in the two semi-circular portions 138, 142 can be considered to form a cam piece selectively defining a non-circular path for the agitating portions 114.

In addition to the mechanism described above, the tracks 146, 148 can be further manipulated by rotation of the cam piece, formed from the two semi-circular portions 138, 142. A first semi-circular portion 142 defines a circular internally-toothed region. The cam piece can be rotated into a desired rotational position my driving the worm gear 150 to engage with further gear 152 to drive the internal teeth of the first semi-circular portion 142. Thus, the first semi-circular portion 142 and a second semi-circular portion 138 can be rotated together relative to the wheel 104A to move the position relative to the body 102 at which the agitating portions 114 extend most from the surface of the wheel 104A, thereby allowing control of the direction of movement of the device 100.

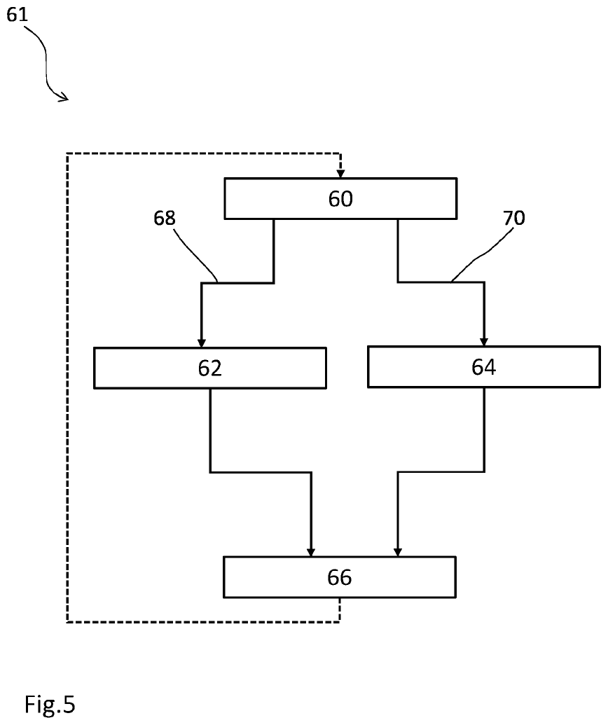

FIG. 5 is a flow chart of example steps in a method 61 for moving the device. Here, the method is typically performed by a controller and includes the step of receiving 60 a signal indicative of whether or not the device 1, 100, is at the surface of the granular medium. If the signal is a signal indicative that the device is at the surface of the granular medium 68, the method comprises extending 62 the agitating portions 114. The method subsequently comprises moving 66 the wheels 104A, 104B. Conversely, if the signal is a signal indicative that the device is not at the surface of the granular medium 70, the method comprises retracting 64 the agitating portions 114. The method subsequently comprises moving 66 (i.e., rotating) the wheels 104A, 104B. The method may be repeated. In other words, the method subsequently comprises (again) receiving 60 a further signal indicative of whether or not the device 1, 100, is at the surface of the granular medium.

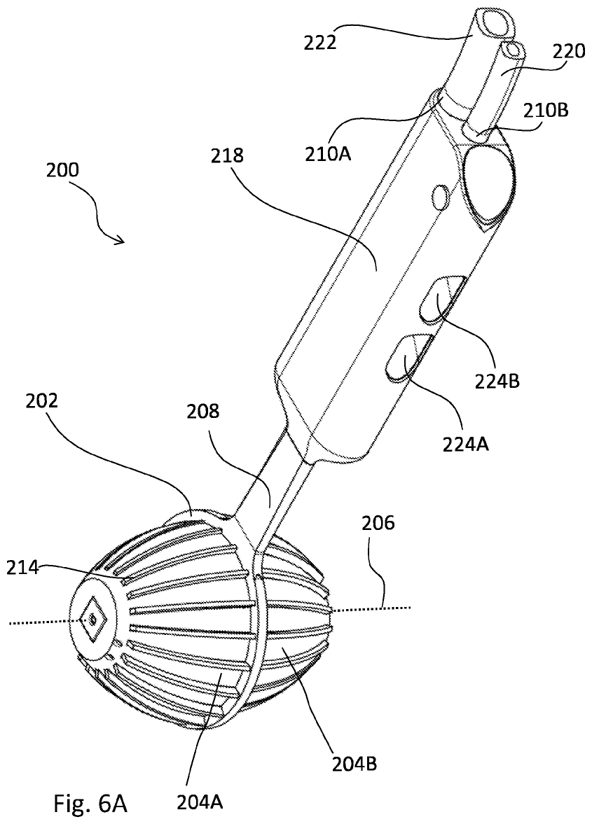

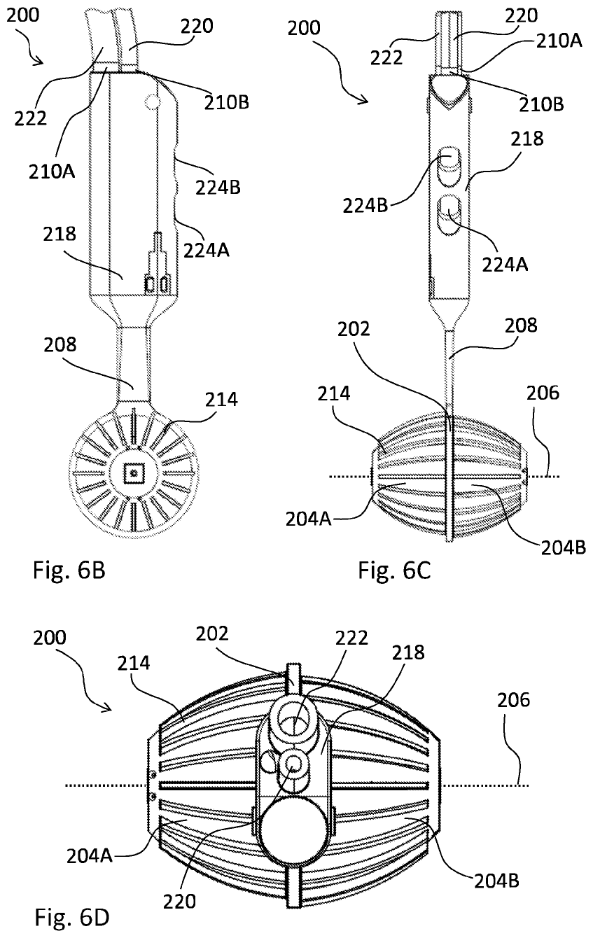

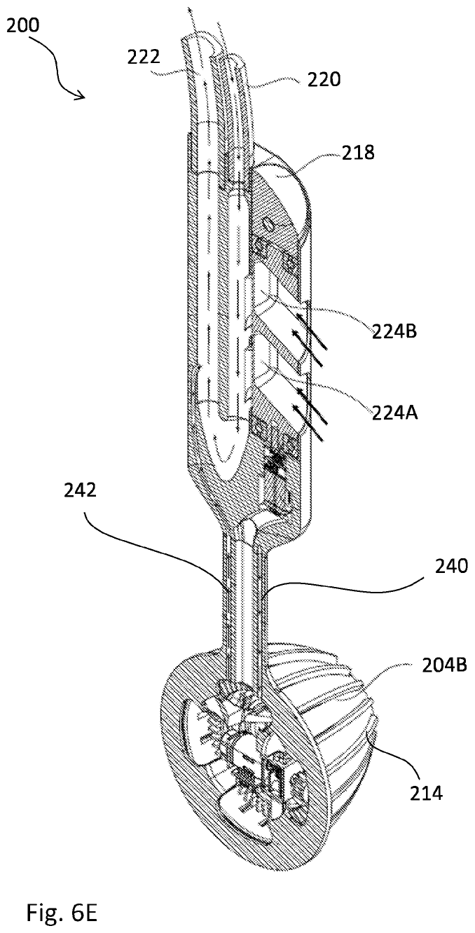

FIG. 6A is a diagram of a device 200 for moving through a granular medium made up of grains and capturing samples of the grain. The device 200 is generally spherical and comprises a body 202 and first and second generally hemispherical rotatable parts in the form of two wheels 204A, 204B located at either side of the body 202. The outer surface of each wheel 204A, 204B has a plurality of agitating portions 214 as described hereinbefore. In this example, the agitating portions 214 are provided in the form of a series of fins, surrounding the outer surface of each wheel 204A, 204B. The body 202 contains two wheel motors (not shown), and a dedicated power source (not shown). The two wheel motors are for driving rotation of the wheels 204A, 204B, about a rotation axis 206. A narrow, elongate protrusion 208 extends from the body 202. The protrusion 208 is connected to a grain sampler 218. The grain sampler 218 has two connectors in the form of ports 210A, 210B via which the grain sampler 218 is connected to two tethers in the form of an air conduit 220 and a grain conduit 222. The grain sampler also has two grain inlets 224A and 224B for receiving grain to be sampled. FIGS. 6B, 6C, and 6D are side and front elevation diagrams and a plan diagram of the device 1 of FIG. 6A, respectively.

As in the example embodiments shown in FIGS. 1A to 1D and FIGS. 3A to 3D, and described above, when the device 200 is submerged in a granular medium, rotation of the wheels 204A, 204B about the rotation axis 206 causes the device 200 to travel through the granular medium. Specifically, the two wheel motors generate a torque on the wheels 204A, 204B which in turn generates a rotation torque of the body in the opposite rotational direction. The protrusion 208 (as well as the grain sampler 218 and tethers, here provided in the form of an air conduit 220, and a grain conduit 222) then resists the rotational movement of the body 202 about the rotation axis 206 thus allowing the device 200 to travel within the granular medium.

As can be most clearly in FIG. 6E, which is a cut-away perspective view diagram of the device 200 of FIG. 6A, in use, an airflow of pressurised air enters the air conduit 220 and travels towards the grain inlets 224A, 224B where the pressurised air mixes with the grains of the granular medium adjacent to the grain sampler 218, encouraging a sample of grain to enter the grain sampler 218 via the grain inlets 224A, 224B, thus capturing a sample of grain. In this example embodiment, the pressurised air and the sample of grain then leave the grain sampler 218 (and the granular medium) via the grain conduit 222. In FIG. 6E, the airflow path for the pressurised air is shown with thin-line arrows through the conduits 220, 222 and the path taken by the grain sample is shown in solid arrows at the grain inlets 224A, 224B. The example device 200 shown in FIG. 6 also includes a cooling air source conduit 240 for receiving cooler air from the air conduit 220 for cooling the components of the device 200 within the body 202 and the wheels 204A, 204B. The air is provided back out of the device via a cooling air exhaust conduit 242 to the grain conduit 222.

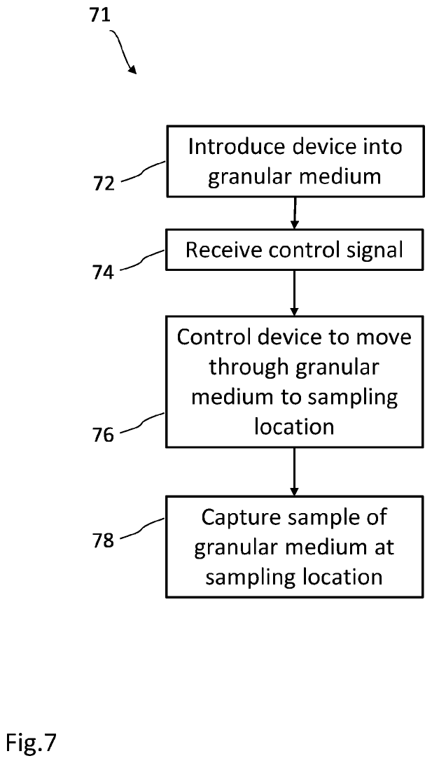

FIG. 7 is a flow chart of example steps in a method of capturing a sample of granular material according to an example aspect of the disclosure. In general, the method 71 includes introducing the device into the granular medium 72. The device is typically any of the devices described hereinbefore including a sampling portion. The method 71 further comprises receiving 74 a control signal. The control signal is indicative of a sampling location at which the device is to sample the granular medium. The method 71 further comprises controlling 76 the device to move through the granular medium to the sampling location in accordance with the control signal. The method 71 further comprises capturing 78 a sample of granular medium at the sampling location. Optionally, the method 71 can also include removing the sample from the granular medium (not shown in FIG. 7).

Advantageously, a user may then carry out analysis of the sample. However, in alternative embodiments of the method, the sample may not be removed away from the granular medium and instead analysis may be carried out whilst the sample is retained by the grain sampler 218 (and the sample may then optionally be released back to the granular medium or may be removed from the granular medium. In some alternative embodiments of the method, the method may include causing the device to move to the surface of the granular medium (optionally whilst retaining the said sample) where it may be retrieved by a user.

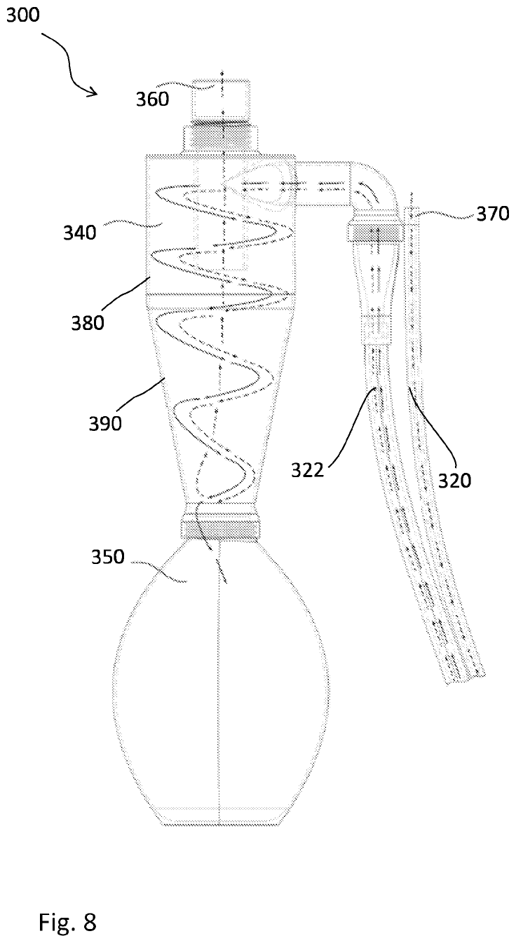

FIG. 8 is a cut-away front elevation diagram of an example of pressurised air equipment 300 that could be used to provide the pressurised air and for receiving a captured sample, however the skilled person will appreciate that other equipment or methods could also be used. The equipment 300 has a cyclone 340 formed within a cylinder having an inner cylindrical surface 380 and a cone having an inner conical surface 390. The equipment 300 also has a reservoir 350, as well as an outlet connection 360 for connecting the equipment 300 to an external vacuum source. As in FIG. 6E, the airflow path for the pressurised air is shown with dashed arrows and the path taken by the grain sample is shown in solid arrows.

In use, compressed air enters the pipe at inlet point 370 and travels downward via air conduit 320 (the same conduit as air conduit 220 in FIGS. 6A to 6E) until reaching device 200 where it mixes with granular material entering the grain sample 218 via the grain inlets 224A, 224B. Air mixed with the said granular material then travels upward via the grain conduit 322 (the same conduit as grain conduit 222 in FIGS. 6A to 6E) and then enters the cyclone 340 where the grains move around the vertical axis (not shown) travelling substantially along a path following the inner cylindrical surface 380 until the grains fall under gravity and follow substantially along a path following the inner conical surface 390 and finally to the reservoir 350 where grains are separated from the airflow. The air then travels upward along the vertical central axis (not shown) and exits the cyclone via outlet connection 360. The collected grains can then be conveniently retrieved by a user. In this example, the grain inlets 224A, 224B can be selectively opened and closed by rotation around a vertical axis, such that the inlets of the grain sample 218 become closed off from an external environment of the device 200 (i.e., the granular medium), and the grain pockets 224A, 224B are oriented and open toward the inner conduits 220, 222 to facilitate passage of the sample of granular medium in the grain pockets 224A, 224B into the conduits 220, 222 and away from the device 200.

The advantage of providing a device 200 for moving through a granular medium made up of grains having a grain sampler 218 is that this allows a sample of a grain to be collected without the need for a user to collect such a sample manually.

In alternative examples, the tether 12 may include a power cable for supplying power to the device 1, 100, 200 and/or may include one or more communications cable for transmitting information to the device 1, 100, 200 and/or for receiving data from the device 1, 100, 200. The connector 10 may include a slip ring. In some alternative examples the one or more sensors may be mounted on the body 2, 102, 202 or the protrusion 8, 108A, 108B, 208.

The device 1, 100, 200 may be remote-controlled (in which case the vehicle may include a receiver and a transmitter for communicating with a remote-control unit) or the device 1, 100, 200 may be autonomous. Such a device 1, 100, 200 could be used in underground investigations, for object retrieval, in planetary exploration, or in (cereal, seed or pulse) grain or powder (e.g. cement) silos.

Where a grain sampler 218 is provided, in some alternative embodiments the grain sampler 218 may be configured to capture a sample of grain but may not have a grain conduit 222, in which case the grain sample may be retrieved when the device 1, 100, 200 moves to the surface of the granular medium. Alternatively, the device 1, 100, 200 may comprise sensors and tests may be carried out on the sample without the sample being removed from the granular medium, in which case the sample may optionally then be returned to the granular medium.

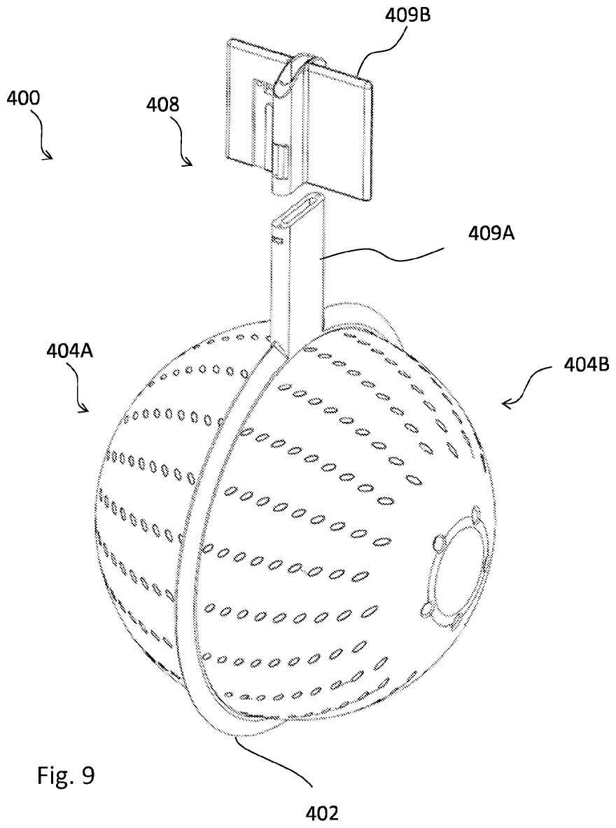

FIG. 9 is a diagram showing a further example of a device as disclosed herein. The device 400 is substantially as described with reference to the devices 1, 100, 200 described hereinbefore apart from the hereinafter noted differences. The protrusion of the device 400 extends from the body 402, and is formed from a first protrusion portion 409A and a second protrusion portion 409B. As described with reference to other devices 1, 100, 200, the body 402 also has extending therefrom two rotatable parts 404A, 404B. The first protrusion portion 409A extends from the body 402. The second protrusion portion 409B is detachably connected to the first protrusion portion 409A. In this example, the second protrusion portion 409B may be selected as one of a plurality of different second protrusion portions (alternatives not shown), any one of which can be attached to the first protrusion portion 409A as required. Each of the plurality of different second protrusion portions may be shaped differently, and/or may be provided with different components, such as different sensors. In this way, the first protrusion portion 409A can be provided permanently connected to the body 402 of the device, and the second protrusion portion 409B can be selected for attachment to the first protrusion portion 409A as necessary. The second protrusion portion 409B is typically connected to the first protrusion portion 409A through fastening means, for example in the form of a fastener, such as one or more threaded fasteners like one or more screws or bolts. In this way, the shape and/or functionality of the protrusion 408 can be altered by replacing the second protrusion portion 409B depending on the environmental conditions in which the device 400 is to be operated, or the task to be performed by the device 400.

Other applications of the device 1, 100, 200, 400 include: the retrieval of seabed or under-seabed objects such as oil pipes, electricity cable networks and seabed monitoring equipment buried by turbidity currents or sand avalanches; freeing vehicles, such as cars, whose wheels are trapped in sand; removal of pipes from the ground; and movable foundations for buildings.

Further variations and modifications may be made within the scope of the invention herein disclosed.

In summary, there is provided a device (1) for moving through a granular medium, the device comprising: a body (2); a rotatable part (4A, 4B) for rotational movement relative to the body about a rotational axis (6), wherein the rotatable part is externally-exposed and arranged to cause agitation of an adjacent portion of a granular medium in which the device is to be provided; a motor configured to cause the rotational movement of the rotatable part; and a protrusion (8) arranged to extend from the body and to limit rotational movement of the body about the rotational axis relative to the granular medium when the motor causes rotational movement of the rotatable part relative to the granular medium.

Throughout the description and claims of this specification, the words “comprise” and “contain” and variations of them mean “including but not limited to”, and they are not intended to and do not exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

### LIST OF REFERENCE NUMERALS

1. Device
2. Body
4A, 4B. Rotatable part, wheel
6. Rotational axis
8. Protrusion
10. Connector
12. Tether
14. Agitating portions
50. Relatively higher pressure region
52. Relatively lower pressure region
61. A method for moving the device
60. Receive surface position signal
62. Extend agitating portions
64. Retract agitating portions
66. Move wheel
68. A signal is received indicating that the device is at the surface of the granular medium
70. A signal is received indicated that the device is not at the surface of the granular medium
71. A method of sampling granular medium
72. Introducing the device into the granular medium
74. Receiving control signal
76. Controlling device to move through granular medium to sampling location
78. Capturing a sample of granular medium at sampling location
100. Device
102. Body
104A, 104B. Rotatable part, wheel
106. Rotational axis
108A, 108B. Protrusion
113. Agitating portion undercarriage
114. Agitating portions
126. Ring
128. Arcuate slots
130. Pegs
132. Expanding arcs
137. Expanding arc track
138. Second semi-circular portion
139. Locator portions
140. First expandable connection
142. First semi-circular portion
144. Second expandable connection
146. Outer track
148. Inner track
150. Worm gear
152. Further gear
154. Gear
200. Device
202. Body
204A, 204B. Rotatable part, wheel
206. Rotational axis
208. Protrusion
210A, 210B. Connector
214. Agitating portions
218. Grain sampler
220. Air conduit
222. Grain conduit
224A, 224B. Grain inlet
240. Cooling air source conduit
242. Cooling air exhaust conduit
300. Pressurised air equipment
320. Air conduit
322. Grain conduit
340. Cyclone
350. Reservoir
360. Outlet connection
370. Inlet point
380. Inner cylindrical surface
390. Inner conical surface
400. Device
402. Body
404A, 404B. Rotatable part
408. Protrusion
409A. First Protrusion Portion
409B. Second Protrusion Portion

1. (canceled)

2. (canceled)

3. (canceled)

4. (canceled)

5. (canceled)

6. (canceled)

7. A device for moving through a granular medium, the device comprising:
a body;
a rotatable part for rotational movement about a rotational axis, the rotatable part being externally-exposed and arranged to cause agitation of an adjacent portion of a granular medium in which the device is to be provided;
a motor configured to cause the rotational movement of the rotatable part; and
one or more agitating portions provided with the rotatable part to cause the agitation of the adjacent portion of the granular medium, and
wherein at a first rotational position of the rotatable part relative to the body, the device is configured such that a first portion of the rotatable part and the one or more agitating portions cause a first degree of agitation in a first region of the granular medium and a second portion of the rotatable part and the one or more agitating portions cause a second degree of agitation in a second region of the granular medium, and
at a second rotational position of the rotatable part relative to the body, the first portion of the rotatable part and the one or more agitating portions cause the second degree of agitation in the second region of the granular medium.

8. The device according to claim 7, wherein the device has a further configuration in which at the first rotational position of the rotatable part relative to the body, the device is configured such that the first portion of the rotatable part and the one or more agitating portions cause the second degree of agitation in the first region of the granular medium.

9. The device according to claim 7, wherein at least one of the one or more agitating portions is moveable between a first position and a second position, the first position extended further than the second position.

10. The device according to claim 9, wherein the device further comprises:
a cam, the cam being connected to the at least one of the one or more agitating portions and movable independently of the rotatable part; and
a cam motor, the cam motor being operable to cause rotation of the cam relative to the body,
wherein rotation of the cam causes movement of the at least one of the one or more agitating portions between the first position and the second position.

11. The device according to claim 10, wherein rotation of the cam to a first cam position causes movement of a first region of the one or more agitating portions to the second position and movement of a second region of the one or more agitating portions to the first position, and wherein rotation of the cam to a second cam position causes movement of a third region of the one or more agitating portions to the second position and movement of a fourth region of the one or more agitating portions to the first position.

12. The device according to claim 7, wherein the rotatable part defines one or more apertures through which the one or more agitating portions may be extended and/or retracted.

13. The device according to claim 7, wherein the device comprises one or more agitating portions provided with the rotatable part to cause the agitation of the adjacent portion of the granular medium, the one or more agitating portions being movable relative to an outer surface of the rotatable part in a direction having at least a component normal to the outer surface of the rotatable part to alter a degree of the agitation of the adjacent portion of the granular medium that is caused when the rotatable part is caused to move relative to the granular medium.

14. A device for moving through a granular medium, the device comprising:
a body;
a rotatable part for rotational movement about a rotational axis, the rotatable part being externally-exposed and arranged to cause agitation of an adjacent portion of a granular medium in which the device is to be provided;
a motor configured to cause the rotational movement of the rotatable part; and
one or more agitating portions provided with the rotatable part to cause the agitation of the adjacent portion of the granular medium,
wherein the one or more agitating portions is movable relative to an outer surface of the rotatable part in a direction having at least a component normal to the outer surface of the rotatable part to alter a degree of the agitation of the adjacent portion of the granular medium that is caused when the rotatable part is caused to move relative to the granular medium.

15. The device according to claim 7 comprising a sampling portion operable to selectively capture a sample of the granular medium for removal from the granular medium.

16. A device for sampling granular material from within a granular medium, the device comprising:
a body;
a rotatable part for rotational movement about a rotational axis, the rotatable part being externally-exposed and arranged to cause agitation of an adjacent portion of a granular medium in which the device is to be provided;
a motor configured to cause the rotational movement of the rotatable part to thereby move the device through the granular medium; and
a sampling portion operable to selectively capture a sample of granular material from the granular medium for removal from the granular medium.

17. The device according to claim 7, wherein a maximum extent of the rotatable part in a direction transverse to the rotational axis is greater than five times a mean maximum extent of grains forming the granular medium.

18. The device according to claim 7, wherein the device comprises a sensor for outputting a signal indicative of a depth position of the device within the granular medium.

19. (canceled)

20. (canceled)

21. (canceled)

22. (canceled)

23. (canceled)

24. (canceled)

25. The device of claim 7, wherein the granular medium is a dry granular medium and comprises foodstuffs, and wherein the granular medium is retained within a silo.

26. The device of claim 7, comprising a protrusion arranged to extend from the body and to resist rotational movement of the body about the rotational axis relative to the granular medium when the motor causes rotational movement of the rotatable part relative to the granular medium.

27. The device of claim 26, wherein the body, the protrusion, and the rotatable part each have an outer surface area, and wherein the outer surface area of the protrusion contributes less than 15% to the total combined surface area of the body, the protrusion, and the rotatable part.

28. The device of claim 26, wherein the body and the protrusion each have a length, and wherein the length of the protrusion is at least 20% of the combined length of the protrusion and the body.

29. The device of claim 7, wherein the device comprises a tether.

30. The device of claim 26, wherein the protrusion comprises a connector for connecting the body to a tether via the protrusion.
